(19) United States
(12) Patent Application Publication
(10) Pub. No.: US 2024/0246621 A1
(43) Pub. Date: Jul. 25, 2024

(54) TENSIONING ASSEMBLIES FOR VEHICLES WITH A TRACK SYSTEM

(71) Applicant: SOUCY INTERNATIONAL INC., Drummondville (CA)

(72) Inventors: Jeremie AUBIN-MARCHAND, St-Hugues (CA); Gabriel CHANTAL, Saint-Jude (CA); Styve ALLIE, Drummondville (CA); Gabriel LANDRY, Saint-Mathieu-de-Laprairie (CA); Yan ROGER, Drummondville (CA)

(21) Appl. No.: 18/421,876

(22) Filed: Jan. 24, 2024

Related U.S. Application Data
(60) Provisional application No. 63/453,306, filed on Mar. 20, 2023.
(60) Provisional application No. 63/440,752, filed on Jan. 24, 2023.

(51) Int. Cl. B62D 55/30

(52) U.S. Cl. CPC B62D 55/30

(57) ABSTRACT

A tensioning assembly for modulating a tension in a track of a vehicle track system, the vehicle track system including a wheel with a wheel axle, the track extending at least partially around the wheel, the tensioning assembly comprising: an indicator for providing an indication when the wheel axle is in a predetermined position corresponding to a predetermined tension in the track, the indication being based on one or both of (i) a predetermined position of a first member of the tensioning assembly relative to a second member of the tensioning assembly, and (ii) a predetermined position of the resilient assembly relative to a frame.

### CROSS-REFERENCE

The present application claims priority to U.S. Provisional Patent Application No. 63/440,752, filed Jan. 24, 2023, and U.S. Provisional Patent Application No. 63/453,306, filed Mar. 20, 2023, both of which are incorporated by reference herein in their entirety.

### TECHNICAL FIELD

The present application generally relates to tensioning assemblies for vehicles with a track system.

### BACKGROUND

Certain vehicles, such as, for example, agricultural vehicles (e.g., harvesters, combines, tractors, etc.), construction vehicles (e.g., trucks, front-end loaders, etc.) and recreational vehicles (e.g., all-terrain vehicles, utility-terrain vehicles, side-by-side vehicles, etc.) are used on ground surfaces that are soft, slippery and/or uneven (e.g., soil, mud, sand, ice, snow, etc.).

Conventionally, such vehicles have had large wheels with tires on them to move the vehicle along the ground surface. Under certain conditions, such tires may have poor traction on some kinds of ground surfaces and, as these vehicles are generally heavy, the tires may compact the ground surface in an undesirable way owing to the weight of the vehicle. For example, when the vehicle is an agricultural vehicle, the tires may compact the soil in such a way as to undesirably inhibit the growth of crops. When the vehicle is a recreational vehicle, the tires may lack traction on certain terrain and in certain conditions.

In order to reduce the aforementioned drawbacks, to increase traction and to distribute the weight of the vehicle over a larger area on the ground surface, track systems were developed to be used in place of at least some of the wheels and tires on the vehicles. For example, under certain conditions, track systems enable agricultural vehicles to be used in wet field conditions as opposed to its wheeled counterpart. In other conditions, track systems enable recreational vehicles to be used in low traction terrains such as snowy roads. Track systems comprises an endless track extending around wheel assemblies.

For proper operation, the endless track must maintain a predetermined tension in the track. In conventional track systems, adjusting the tension in the track is not easy and requires some amount of dismantling of parts of the track system, or of the vehicle. Furthermore, it is not readily apparent, during modulating a tension in the prior art track systems, whether a desired tension has been achieved in the track.

Therefore, there is desire for tensioning assemblies for track systems that could mitigate the above-mentioned issues.

### SUMMARY

It is an object of the present technology to ameliorate at least some of the inconveniences present in the prior art.

According to one aspect of the present technology, there is provided a tensioning assembly for modulating a tension in a track of a vehicle track system, the vehicle track system including a wheel with a wheel axle, the track extending at least partially around the wheel, the tensioning assembly comprising: a shaft connectable to a frame of the track system, the shaft having a longitudinal axis; a resilient assembly connectable to the wheel axle and operatively connected to the shaft such that when the shaft is rotated about the longitudinal axis the wheel axle is caused to move relative to the frame to modulate the tension in the track, the resilient assembly comprising: a first member threadedly connected to the shaft and configured to be translated along the shaft when the shaft is rotated; a second member connectable to the wheel axle and slidingly connected to the first member such that the second member and the wheel axle are caused resilient member resiliently biasing the second member away from the first member; an indicator for providing an indication when the wheel axle is in a predetermined position corresponding to a predetermined tension in the track, the indication being based on (i) a predetermined position of the first member relative to the second member, and (ii) a predetermined position of the resilient assembly relative to the frame.

In certain embodiments, the resilient assembly is configured to move between a retracted position and a deployed position, the deployed position corresponding to the predetermined position of the wheel axle, wherein the first member and the second member are disposed closer to the wheel axle in the deployed position than in the retracted position.

In certain embodiments, the movement of the first member along the shaft is parallel to the longitudinal axis of the shaft.

In certain embodiments, the first member has a first member open end and a first member base end, and the second member has a second member housing portion comprising a second member housing open end and a second member housing base end, the second member housing portion configured to receive the first member open end, and the resilient member extends between the first member base end and the second member housing base end.

In certain embodiments, the indicator comprises an alignment of the first member base end with the second member open end.

In certain embodiments, the first member and the second member are configured such that the first member base end is aligned with the second member housing open end when the first member open end abuts the second member housing base end.

In certain embodiments, the shaft and the wheel axle are positioned on substantially the same plane.

In certain embodiments, a portion of the frame has a frame face which is parallel to the longitudinal axis of the shaft, the second member further comprising a second member plate portion which is connected to the second member housing portion, the second member plate portion being parallel to the frame face and having a frictional engagement therewith.

In certain embodiments, the second member further comprises second member wing portions extending from either side of the second member plate portion, the second member wing portions being configured such that applying a force on the second member wing portions towards the frame face can modulate the frictional engagement between the second member and the frame.

In certain embodiments, the tensioning assembly further comprises a guide member to guide a movement of the first and/or second member relative to the frame, the guide member comprising a pin extending through the frame face and connected to the second member, wherein the pin is slidable in a slot defined in the frame, the pin extending in a direction transversely to the frame face.

In certain embodiments, the tensioning assembly further comprises a nut on the pin which can be turned to modulate a force applied from the second member to the frame face.

In certain embodiments, the indicator comprises an alignment of the second member open end with a mark on the frame face.

In certain embodiments, the shaft and the wheel axle are disposed on different planes.

In certain embodiments, a portion of the frame has a frame face which is parallel to the longitudinal axis of the shaft, wherein the shaft, the first member and the second member are disposed downwardly of the frame face and the wheel axle is disposed upwardly of the frame face.

In certain embodiments, the tensioning assembly further comprises: a sliding member connected to the wheel axle, the sliding member extending parallel to the frame face and having a frictional engagement therewith; a pin extending from the second member, through the frame face, and connected to the sliding member, to connect the resilient assembly to the wheel axle.

In certain embodiments, the pin extends transversely to the longitudinal axis of the shaft.

In certain embodiments, the tensioning assembly further comprises a nut on the pin which can be turned to modulate a force applied by the second member to the frame face.

In certain embodiments, the sliding member is configured such that the frictional engagement of the sliding member with the frame can be modulated by applying a force on the sliding member towards the frame.

In certain embodiments, the pin extends from an interface of the first member and the second member and has a frictional engagement with the first member.

In certain embodiments, the indicator comprises an alignment of the sliding member with a mark on the frame face.

From a further aspect, there is provided a tensioning assembly for modulating a tension in a track of a vehicle track system, the vehicle track system including a wheel with a wheel axle, the track extending at least partially around the wheel, the tensioning assembly comprising: a shaft threadedly connectable to a frame of the track system, the shaft having a longitudinal axis; a resilient assembly connectable to the wheel axle and operatively connectable to the shaft such that when the shaft is rotated about the longitudinal axis the wheel axle is caused to move relative to the frame to modulate a tension in the track, wherein the resilient assembly is operatively connected to the shaft at a non-threaded portion of the shaft, the resilient assembly comprising: a first member connected to the shaft; a second member connected to the wheel axle and slidingly connected to the shaft, the first and second members configured have be relatively translatable along the non-threaded portion of the shaft as the shaft is rotated about the longitudinal axis; a resilient member resiliently biasing the second member away from the first member; an indicator for providing an indication when the wheel axle is in a predetermined position corresponding to a predetermined tension in the track, the indication being based on (i) a predetermined position of the shaft relative to the frame, and (ii) a predetermined position of the first member to the second member.

In certain embodiments, the shaft and the resilient assembly are configured to move between a retracted position and a deployed position, the deployed position corresponding to the predetermined position of the wheel axle, wherein the first member and the second member are disposed closer to the wheel axle in the deployed position than in the retracted position.

In certain embodiments, the relative movement of the first member and the second member along the shaft is parallel to the longitudinal axis of the shaft.

In certain embodiments, the shaft and the wheel axle are positioned on substantially the same plane.

In certain embodiments, the resilient assembly includes a first delimiting member on the shaft which delimits the movement of the first member away from the wheel axle along the non-threaded portion of the shaft when the shaft is rotated.

In certain embodiments, the first member has a first member open end and a first member base end, and the second member has a second member open end and a second member base end, the first member and the second member disposed on the shaft so that the first member open end and the second member open end can face one another, each of the first member and the second member housing a respective end of the resilient member.

In certain embodiments, the second member comprises an elongate member extending away from the second member base end and receivable in an opening in the first member base end, the elongate member having a tip which is visible when the first member and the second member are in the predetermined position.

In certain embodiments, the first member and the second member are configured to abut one another at the predetermined position.

In certain embodiments, the shaft is threadedly connected with the frame at a first connection point and extends through the first member and the second member and is connected to the wheel axle at a second connection point.

In certain embodiments, the tensioning assembly further comprises a third connection point between the wheel axle and the frame.

In certain embodiments, the first connection point comprises a pivotal connection between the frame and the shaft, and the second connection point comprises a pivotal connection between the wheel axle and the shaft.

In certain embodiments, the first connection point comprises a first spherical joint, and the second connection point comprises a second spherical joint.

In certain embodiments, the third connection point comprises a third spherical joint.

In certain embodiments, the tensioning assembly further comprises an arm extending from the frame to the wheel axle, wherein a length of the arm is adjustable.

In certain embodiments, the second connection point comprises a pair of second connection points, and the arm comprises a pair of arms, each second connection point of the pair of second connection points is connected to a respective third connection point, and wherein each third connection point is connected to the frame by a respective arm of the pair of arms, wherein each arm of the pair of arms has a length which is a individually adjustable.

In certain embodiments, the resilient member has a length which is modulated responsive to the relative movement of the first and second members when the shaft is rotated about its longitudinal axis, wherein the length is selected such that the resilient member is compressed when the first member and the second member are in the predetermined position.

From a yet further aspect, there is provided a tensioning assembly for modulating a tension in a track of a vehicle track system, the vehicle track system including a wheel with a wheel axle, the track extending at least partially around the wheel, the tensioning assembly comprising: a shaft threadedly connectable to a frame of the track system, the shaft having a longitudinal axis; a resilient assembly connectable to the wheel axle and operatively connectable to the shaft such that when the shaft is rotated about the longitudinal axis the wheel axle is caused to move relative to the frame to modulate a tension in the track, wherein the resilient assembly is operatively connected to the shaft at a non-threaded portion of the shaft, the resilient assembly comprising: a first member connected to the shaft; a second member connected to the wheel axle and slidingly connected to the first member such that the second member and the wheel axle are caused to move relative to the frame when the first member is moved; a resilient member resiliently biasing the second member away from the first member; an indicator for providing an indication when the wheel axle is in a predetermined position corresponding to a predetermined tension in the track, the indication being based on (i) a predetermined position of the shaft relative to the frame, and (ii) a predetermined position of the first member to the second member.

In certain embodiments, the shaft and the resilient assembly are configured to move between a retracted position and a deployed position, the deployed position corresponding to the predetermined position of the wheel axle, wherein the first member and the second member are disposed closer to the wheel axle in the deployed position than in the retracted position.

In certain embodiments, the relative movement of the second member to the first member is parallel to the longitudinal axis of the shaft.

In certain embodiments, the shaft and the wheel axle are positioned on substantially the same plane.

In certain embodiments, the first member has a first member open end and a first member base end, and the second member has a second member open end and a second member base end, the second member configured to receive the first member open end, and the resilient member extends between the first member base end and the second member housing base end.

In certain embodiments, the indicator comprises an alignment of the first member base end with the second member open end.

In certain embodiments, the first member and the second member are configured such that the first member base end is aligned with the second member open end when the first member open end abuts the second member base end.

In certain embodiments, the tensioning assembly further comprises a protrusion extending from the second member towards the first member, the resilient member comprising a spring disposed around the protrusion.

In certain embodiments, the tensioning assembly further comprises arms extending from the second member towards the wheel axle, wherein the arms are configured to clamp around the wheel axle.

In certain embodiments, the first member has a first member open end and a first member base end, and the second member has a second member open end and a second member base end, the first member open end facing the second member open end, and the resilient member extending between the first member base end and the second member housing base end.

In certain embodiments, the indicator comprises an abutment of the first member open end with the second member open end.

In certain embodiments, the tensioning assembly further comprises a protrusion extending from the second member towards the first member, the resilient member comprising a spring disposed around the protrusion.

In certain embodiments, the second member is connected to the wheel axle by a second member attachment portion which extends circumferentially around the wheel axle.

From a yet further aspect, there is provided a tensioning assembly for modulating a tension in a track of a vehicle track system, the vehicle track system including a wheel with a wheel axle, the track extending at least partially around the wheel, the tensioning assembly comprising: a shaft having a longitudinal axis and being threadedly connectable at one end to the wheel axle; a resilient assembly operatively connected to the shaft such that when the shaft is rotated about the longitudinal axis the wheel axle is caused to move away or toward the track to modulate the tension in the track, the resilient assembly comprising: a first member connected to a frame of the vehicle track system, the shaft extending through the first member and being slidably connected thereto; a second member connected to the shaft between the first member and the wheel axle; a resilient member resiliently biasing the second member away from the first member; an indicator for providing an indication when the wheel axle is in a predetermined position corresponding to a predetermined tension in the track, the indication being based on at least one of (i) a predetermined position of the first member relative to the second member, and (ii) a predetermined position of the resilient assembly relative to the frame.

In certain embodiments, the second member comprises a shoulder extending from the shaft.

In certain embodiments, a connection between the first member and the frame is configured to provide one of a spherical joint, universal joint and a loose joint.

In certain embodiments, the first member comprises a threaded bushing.

In certain embodiments, the tensioning assembly further comprises a tool interface portion connected to the shaft, the tool interface portion being configured to be used with a ratchet and socket tool.

In certain embodiments, the tensioning assembly further comprises a ratchet mechanism connected to the shaft, such that rotating the shaft about the longitudinal axis causes the shaft to be translated laterally towards the wheel axle.

In certain embodiments, the shaft is configured such that rotating the shaft about the longitudinal axis causes the shaft to be translated laterally towards and away from the wheel axle.

In certain embodiments, the lateral translation of the shaft is parallel to an axis of the first member.

In certain embodiments, the resilient member is made of a material having stable and predictable elastic properties over a range of temperature of operation of the vehicle track system.

In certain embodiments, the resilient member is a spring or a belleville washer.

In certain embodiments, the indicator is a visual reference or a hard stop reference.

In certain embodiments, the resilient member is a spring and the visual reference is a distance between coils of the spring.

In certain embodiments, the indicator is a pointer connected to the frame which is spaced from the resilient member and pointing towards the shoulder, the indicator indicates that the wheel axle is in the predetermined position when the pointer is aligned with an alignment point on the shaft or on the resilient member.

In certain embodiments, the shaft and the wheel axle are positioned on substantially the same plane.

In certain embodiments, the shaft is configured to move between a retracted position and a deployed position, the deployed position corresponding to the predetermined position of the wheel axle.

In certain embodiments, the shaft has a connection end and a free end, wherein the shaft is connected to the wheel axle at the free end, and wherein the connection end can be accessed through an opening in the frame.

In certain embodiments, the wheel axle is connected to the frame by a pivot member.

In certain embodiments, the pivot member has a first end which is rotatably connected to the wheel axle, and a second end which is rotatably connected to the frame.

In certain embodiments, the pivot member is connectable to the frame via at least two positions to accommodate different sizes of sprocket wheels.

In certain embodiments, in the retracted position the first end of the pivot member is disposed between the second end of the pivot member and the resilient assembly.

In certain embodiments, in the deployed position, the second end of the pivot member is disposed between the first end of the pivot member and the resilient assembly.

From another aspect, there is provided a tensioning assembly for modulating a tension in a track of a vehicle track system, the vehicle track system including a wheel with a wheel axle, the track extending at least partially around the wheel. The tensioning assembly comprises a sleeve slidably housing a shaft, the sleeve being slidably connected to a frame of the track system, the sleeve having a longitudinal axis; a resilient assembly connectable to the wheel axle and operatively connectable to the shaft such that when the sleeve is rotated about the longitudinal axis the wheel axle is caused to move relative to the frame to modulate a tension in the track, wherein the resilient assembly is operatively connected to the shaft, the resilient assembly comprising: a first member connected to the sleeve; a second member connected to the shaft and connected to the wheel axle via a pivot member, the second member being slidably movable relative to the first member such that the second member and the wheel axle are caused to move relative to the frame when the first member is moved; a resilient member resiliently biasing the second member away from the first member; an indicator for providing an indication when the wheel axle is in a predetermined position corresponding to a predetermined tension in the track, the indication being based on (i) a predetermined position of the sleeve or the shaft relative to the frame, and (ii) a predetermined position of the first member to the second member.

In certain embodiments, the sleeve is slidably connected to a hinge member, and the hinge member is pivotably connected to the frame.

From a yet further aspect, there is provided a tensioning assembly for modulating a tension in a track of a vehicle track system, the vehicle track system including a wheel with a wheel axle, the track extending at least partially around the wheel, the tensioning assembly comprising: a shaft slidably connected to a frame of the track system and threadedly connected to the wheel axle via a pivot member, the shaft having a longitudinal axis; a resilient assembly connected to the frame and operatively connectable to the shaft such that when the shaft is rotated about the longitudinal axis the wheel axle is caused to move relative to the frame to modulate a tension in the track, wherein the resilient assembly is operatively connected to the shaft, the resilient assembly comprising: a first member connected to the frame; a second member connected to the shaft; a resilient member resiliently biasing the second member away from the first member; an indicator for providing an indication when the wheel axle is in a predetermined position corresponding to a predetermined tension in the track, the indication being based on (i) a predetermined position of the shaft relative to the frame, and (ii) a predetermined position of the first member to the second member.

From a yet further aspect, there is provided a method for adjusting a tension in a track of a vehicle track system by using a tensioning assembly according to any of the aspects and embodiments described above, the method comprising: causing the shaft to be rotated about the longitudinal axis; and determining a tension in the track using the indicator.

In certain embodiments, the resilient member is a spring and the tension in the track is determined by measuring a distance between coils of the spring.

In the context of the present specification, unless expressly provided otherwise, the words “first”, “second”, “third”, etc. have been used as adjectives only for the purpose of allowing for distinction between the nouns that they modify from one another, and not for the purpose of describing any particular relationship between those nouns.

It must be noted that, as used in this specification and the appended claims, the singular form “a”, “an” and “the” include plural referents unless the context clearly dictates otherwise.

As used herein, the term “about” in the context of a given value or range refers to a value or range that is within 20%, preferably within 10%, and more preferably within 5% of the given value or range.

As used herein, the term “and/or” is to be taken as specific disclosure of each of the two specified features or components with or without the other. For example “A and/or B” is to be taken as specific disclosure of each of (i) A, (ii) B and (iii) A and B, just as if each is set out individually herein.

For purposes of the present application, terms related to spatial orientation when referring to a track system and components in relation thereto, such as “vertical”, “horizontal”, “forwardly”, “rearwardly”, “left”, “right”, “above” and “below”, are as they would be understood by a driver of a vehicle to which the track system is connected, in which the driver is sitting on the vehicle in an upright driving position, with the vehicle steered straight-ahead and being at rest on flat, level ground.

Implementations of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects, and advantages of implementations of the present technology will become apparent from the following description, the accompanying drawings, and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 is a left side elevation view of a vehicle having track systems, according to embodiments of the present technology;

FIG. 2 is a perspective view taken from a bottom, front, left side of one of the track systems of FIG. 1, the track system having a tensioning assembly, according to embodiments of the present technology;

FIG. 3 is a perspective view of the tensioning assembly of FIG. 2, according to a first embodiment of the present technology;

FIG. 4 is a top plan view of the tensioning assembly of FIG. 3;

FIG. 5 is a cross-sectional view of the tensioning assembly of FIG. 3 through the line B-B′ of FIG. 4;

FIG. 6 is a cross-sectional view of the tensioning assembly of FIG. 3 through the line A-A′ of FIG. 3;

FIGS. 7A, 7B and 7C are cross-sectional views of the tensioning assembly of FIG. 3 through the line A-A′ of FIG. 3 when in the retracted position, neutral position and deployed position respectively, according to embodiments of the present technology;

FIG. 8 is a perspective view of the tensioning assembly of FIG. 2, according to a second embodiment of the present technology;

FIG. 9 is a side view of the tensioning assembly of FIG. 8;

FIG. 10 is a cross-sectional view of the tensioning assembly of FIG. 8 through the line C-C′ of FIG. 8;

FIG. 11 is a cross-sectional view of the tensioning assembly of FIG. 8 through the line D-D′ of FIG. 9;

FIGS. 12A, 12B and 12C are cross-sectional views of the tensioning assembly of FIG. 8 through the line C-C′ of FIG. 10 when in the retracted position, neutral position and deployed position respectively, according to embodiments of the present technology;

FIG. 13 is a perspective view of the tensioning assembly of FIG. 2, according to a third embodiment of the present technology;

FIG. 14 is a top plan view of the tensioning assembly of FIG. 13;

FIG. 15 is a cross-sectional view of the tensioning assembly of FIG. 8 through the line E-E′ of FIG. 14;

FIGS. 16A and 16B are perspective views of first and second members, respectively, of the tensioning assembly of FIG. 13;

FIG. 17 is a close-up view of the first and second members of FIGS. 16A and 16B when assembled in the tensioning assembly of FIG. 13;

FIGS. 18A, 18B and 18C are cross-sectional views of the tensioning assembly of FIG. 13 through the line E-E′ of FIG. 14 when in the retracted position, neutral position and deployed position respectively, according to embodiments of the present technology;

FIG. 19 is a perspective view of the tensioning assembly of FIG. 2, according to a fourth embodiment of the present technology;

FIG. 20 is a top plan view of the tensioning assembly of FIG. 19;

FIG. 21 is another perspective view of the tensioning assembly of FIG. 19 with a frame removed;

FIG. 22 is a bottom plan view of the tensioning assembly of FIG. 19;

FIGS. 23A, 23B and 23C are cross-sectional views of the tensioning assembly of FIG. 19 through the line F-F′ of FIG. 20 when in the retracted position, neutral position and deployed position respectively, according to embodiments of the present technology;

FIG. 24 is a perspective view of the tensioning assembly of FIG. 2, according to a fifth embodiment of the present technology;

FIG. 25 is a cross-sectional view of the tensioning assembly of FIG. 8 through the line G-G′ of FIG. 24;

FIGS. 26A, 26B and 26C are cross-sectional views of the tensioning assembly of FIG. 24 through the line G-G′ of FIG. 24 when in the retracted position, neutral position and deployed position respectively, according to embodiments of the present technology;

FIG. 27 is a perspective view of the tensioning assembly of FIG. 2, according to a sixth embodiment of the present technology;

FIG. 28 is a close-up of a resilient assembly of the tensioning assembly of FIG. 27;

FIG. 29 is a cross-sectional view of the tensioning assembly of FIG. 27 through the line H-H′ of FIG. 24;

FIGS. 30A, 30B and 30C are cross-sectional views of the tensioning assembly of FIG. 27 through the line H-H′ of FIG. 27 when in the retracted position, neutral position and deployed position respectively, according to embodiments of the present technology;

FIG. 31 is a perspective view of the tensioning assembly of FIG. 2, according to a seventh embodiment of the present technology;

FIG. 32 is a close-up perspective of the tensioning assembly of FIG. 31;

FIG. 33 is a close-up side view of the tensioning assembly of FIG. 31;

FIG. 34 is a cross-sectional view of the tensioning assembly of FIG. 31 through the line I-I′ of FIG. 33;

FIGS. 35A, 35B and 35C are cross-sectional views of the tensioning assembly of FIG. 31 through the line I-I′ of FIG. 33 when in the retracted position, neutral position and deployed position respectively, according to embodiments of the present technology;

FIG. 36 is a perspective view of the tensioning assembly of FIG. 2 in a deployed position, according to an eighth embodiment of the present technology;

FIG. 37 is a partial cross-sectional view of the tensioning assembly of FIG. 36 through the line J-J′ of FIG. 36;

FIG. 38 is a perspective view of the tensioning assembly of FIG. 36 in a retracted position

FIG. 39 is a partial cross-sectional view of the tensioning assembly of FIG. 38 through the line K-K′ of FIG. 38;

FIG. 40 is a perspective view of the tensioning assembly of FIG. 2 in a deployed position, according to a ninth embodiment of the present technology;

FIG. 41 is a perspective view of the tensioning assembly of FIG. 40 in a retracted position;

FIG. 42 is a perspective view of the tensioning assembly of FIG. 2 in a deployed position, according to a tenth embodiment of the present technology;

FIG. 43 is a perspective view of the tensioning assembly of FIG. 42 in a retracted position;

FIG. 44 is a perspective view of the tensioning assembly of FIG. 2 in a deployed position, according to an eleventh embodiment of the present technology; and

FIG. 45 is a perspective view of the tensioning assembly of FIG. 44 in a retracted position.

### DETAILED DESCRIPTION

The present disclosure is not limited in its application to the details of construction and the arrangement of components set forth in the following description or illustrated in the drawings. The disclosure is capable of other embodiments and of being practiced or of being carried out in various ways. Also, the phraseology and terminology used herein is for the purpose of description and should not be regarded as limiting. The use of “including”, “comprising”, or “having”, “containing”, “involving” and variations thereof herein, is meant to encompass the items listed thereafter as well as, optionally, additional items. In the following description, the same numerical references refer to similar elements.

### Off-Road Vehicle

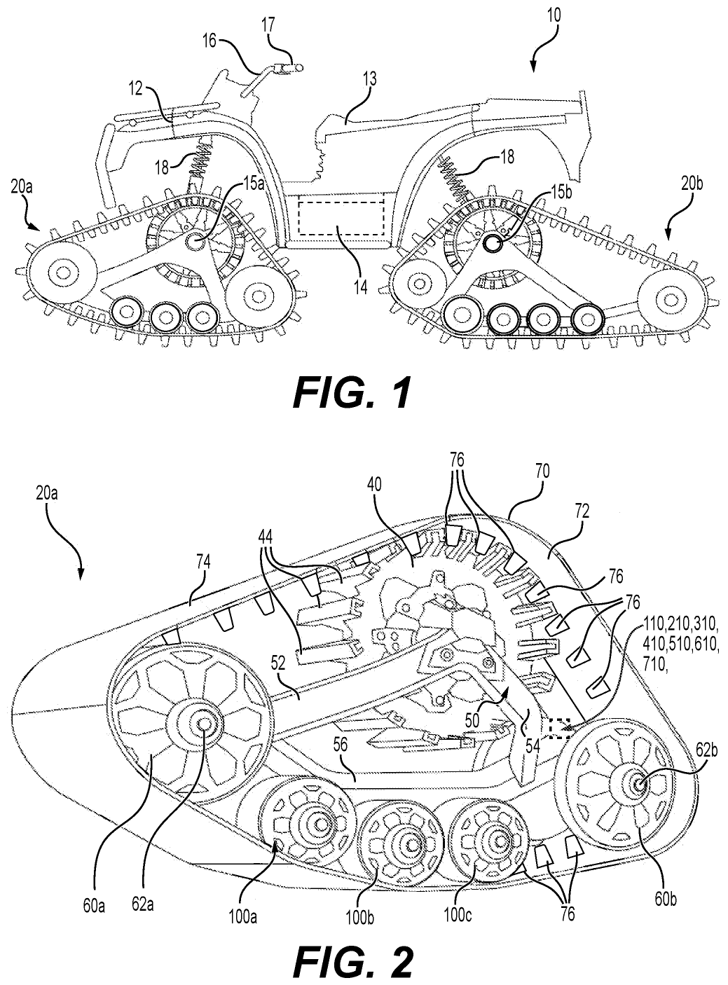

Referring to FIG. 1, the present technology will be described with reference to a vehicle 10. The vehicle 10 is an off-road vehicle 10. More precisely, the vehicle 10 is an all-terrain vehicle (ATV) 10. It is contemplated that in other embodiments, the vehicle 10 could be another type of recreational vehicle such as a snowmobile, a side-by-side vehicle or a utility-task vehicle (UTV).

In yet other embodiments, the vehicle is an agricultural vehicle such as a harvester, a combine or a tractor. In other embodiments, the vehicle is a construction vehicle such as a bulldozer, a skid-steer loader, an excavator or a compact track loader. It is further contemplated that the present technology could be used with industrial and military vehicles as well. It is also contemplated that the present technology could be used with trailers or other unpowered vehicles.

A person skilled in the art will understand that it is also contemplated that some aspects of the present technology in whole or in part could be applied to other types of vehicles such as, for example, agricultural vehicles, industrial vehicles, military vehicles or exploratory vehicles.

The vehicle 10 has two front track systems 20a (only the left one is shown in the accompanying Figures) in accordance with embodiments of the present technology, and two rear track systems 20b (only the left one is shown in the accompanying Figures) also in accordance with embodiments of the present technology. In some embodiments, the vehicle 10 could have more or less than four track systems.

The vehicle 10 includes a frame 12, a straddle seat 13 disposed on the frame 12, a powertrain 14 (shown schematically), a steering system 16, a suspension system 18, and the track systems 20a, 20b.

The powertrain 14, which is supported by the frame 12, is configured to generate power and transmit said power to the track systems 20a, 20b via driving axles, thereby driving the vehicle 10. More precisely, the front track systems 20a are operatively connected to a front axle 15a of the vehicle 10 and, the rear track systems 20b are operatively connected to a rear axle 15b of the vehicle 10. It is contemplated that in some embodiments, the powertrain 14 could be configured to provide its motive power to both the front and the rear axles 15a, 15b, to only the front axle 15a or to only the rear axle 15b (i.e., in some embodiments, the front axle and/or rear axle could be a driving axle). In some embodiments, the track systems 20a, 20b are operatively connected to non-driven axle of unpowered vehicles (e.g. trailer).

The steering system 16 is configured to enable an operator of the vehicle 10 to steer the vehicle 10. To this end, the steering system 16 includes a handlebar 17 that is operable by the operator to direct the vehicle 10 along a desired course. In other embodiments, the handlebar 17 could be replaced by another steering device such as, for instance, a steering wheel. The steering system 16 is configured so that in response to the operator handling the handlebar 17, an orientation of the front track systems 20a relative to the frame 12 is changed, thereby enabling the vehicle 10 to turn in a desired direction.

The suspension system 18, which is connected between the frame 12 and the track systems 20a, 20b allows relative motion between the frame 12 and the track systems 20a, 20b, and can enhance handling of the vehicle 10 by absorbing shocks and assisting in maintaining adequate traction between the track systems 20a, 20b and the ground.

The track systems 20a, 20b are configured to compensate for and/or otherwise adapt to the suspension system 18 of the vehicle 10. For instance, the track systems 20a, 20b are configured to compensate for and/or otherwise adapt to alignment settings, namely camber (i.e., a camber angle, “roll”), caster (i.e., a caster angle, “steering angle” and/or toe (i.e., a toe angle, “yaw”), which are implemented by the suspension system 18. As the vehicle 10 could have been originally designed to use wheels instead of the track systems, the alignment settings could originally have been set to optimize travel, handling, ride quality, etc. of the vehicle 10 with the use of wheels. Since the track systems 20a, 20b are structurally different and behave differently from wheels, the track system 20a, 20b may be configured to compensate for and/or otherwise adapt to the alignment settings to enhance their traction and/or other aspects of their performances and/or use.

### Track System

Referring now to FIG. 2, the track systems 20a, 20b will be described in greater detail. Being that the front and rear track systems 20a, 20b are similar, only the front left track system 20a will be described herein.

The track system 20a includes a sprocket wheel assembly 40 which is operatively connectable to the driving axle 15a. The driving axle 15a can drive the sprocket wheel assembly 40 to drive the track system 20a. The sprocket wheel assembly 40 defines laterally extending engaging members 44 (i.e., teeth) disposed on the circumference of the sprocket wheel assembly 40. The engaging members 44 are adapted, as will be described in greater detail below, to engage with lugs 76 provided on an inner surface 72 of an endless track 70 of the track system 20a. It is contemplated that in other embodiments, the configuration of the sprocket wheel assembly 40 and thus the manner in which the sprocket wheel assembly 40 engages the endless track 70 could differ without departing from the scope of the present technology.

The track system 20a further includes a frame 50. The frame 50 includes a leading frame member 52, a trailing frame member 54 and a lower frame member 56. The leading and trailing frame members 52, 54 are jointly connected around the driving axle 15a, the joint connection being positioned laterally outwardly from the sprocket wheel assembly 40. The leading frame member 52 extends forwardly and downwardly from the joint connection and connects to a forward portion of the lower frame member 56. The trailing frame member 54 extends rearwardly and downwardly from the joint connection and connects to a rearward portion of the lower frame member 56. The lower frame member 56, which is positioned below the joint connection, extends generally parallel to the forward direction of travel of the vehicle. In the present embodiment, the leading, trailing and lower frame members 52, 54, 56 are integral. It is contemplated that in other embodiments, the leading, trailing and lower frame members 52, 54, 56 could be distinct members connected to one another. It is contemplated that in other embodiments, the configuration of the frame 50 could differ without departing from the scope of the present technology. For instance, it is further contemplated that in some embodiments, the frame 50 could include more or less than three members. In some embodiments, one or more of the leading, trailing and lower frame members 52, 54, 56 could be pivotally connected to one another.

With continued reference to FIG. 2, the track system 20a further includes a leading idler wheel assembly 60a, a trailing idler wheel assembly 60b, and a plurality of support wheel assemblies 100a, 100b, 100c. In this embodiment, the track system 20a includes three support wheel assemblies, but it is contemplated that the track system 20a could include more or less than three support wheel assemblies. Each of the leading and trailing idler wheel assemblies 60a, 60b and the support structures 100a, 100b, 100c includes two laterally spaced wheels 112a, 112b. It is contemplated that in some embodiments, at least one of the leading and trailing idler wheel assemblies 60a, 60b, and the support wheel assemblies 100a, 100b, 100c could have a single wheel, or three or more laterally spaced wheels.

The leading idler wheel assembly 60a has a wheel axle 62a and is rotationally connected to a leading end of the lower frame member 56. The trailing idler wheel assembly 60b has a wheel axel 62b and is rotationally connected to a trailing end of the lower frame member 56. The support wheel assemblies 100a, 100b, 100c, which will be described in greater detail below, are connected to the lower frame member 56 longitudinally between the leading and trailing idler wheel assemblies 60a, 60b.

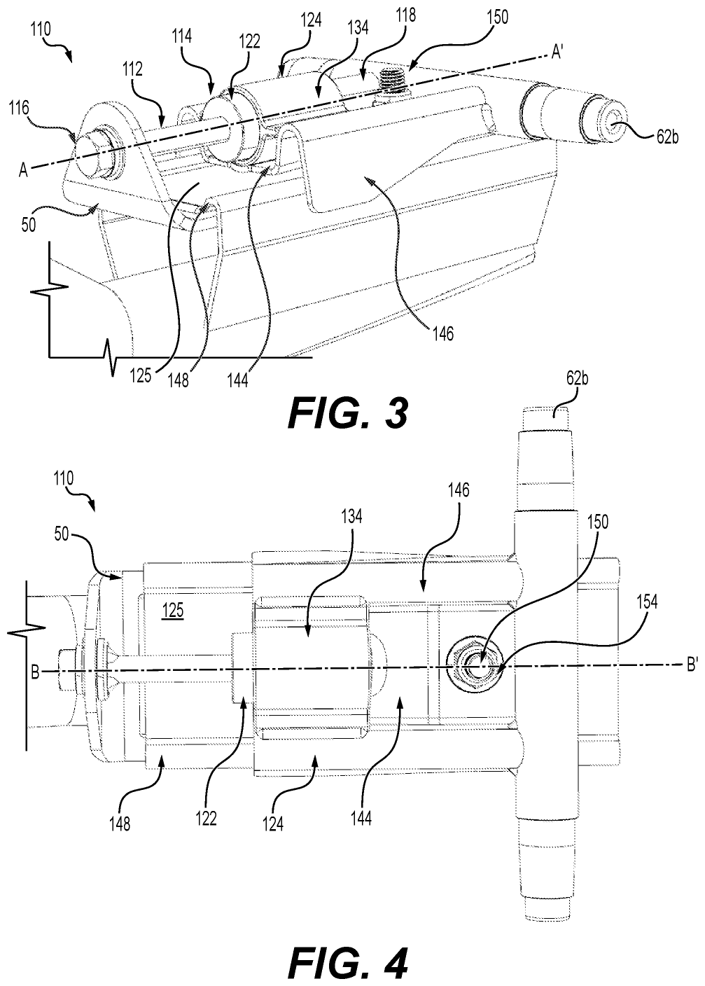

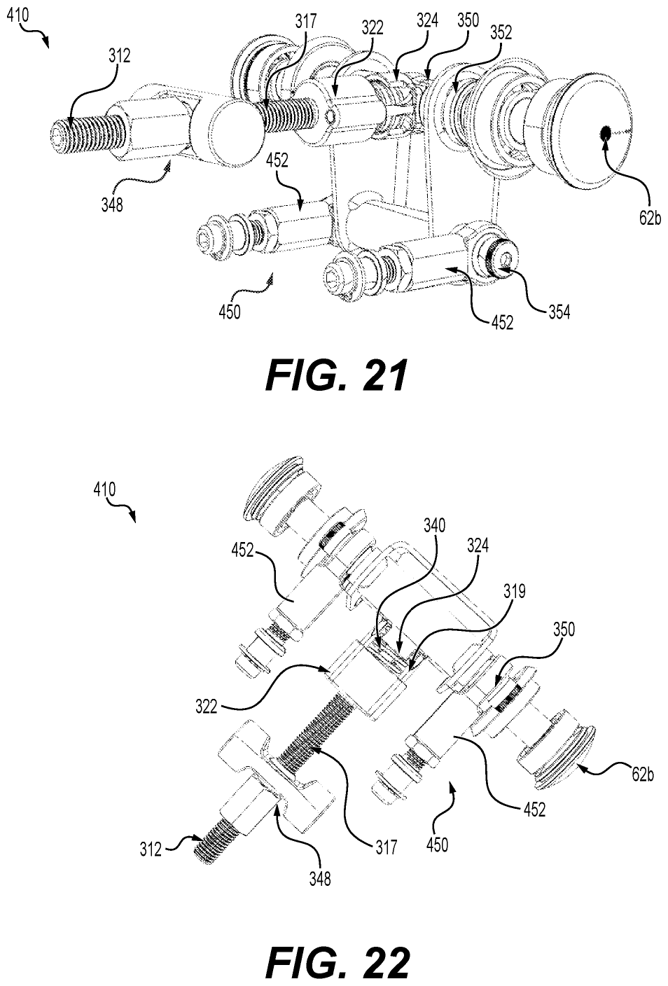

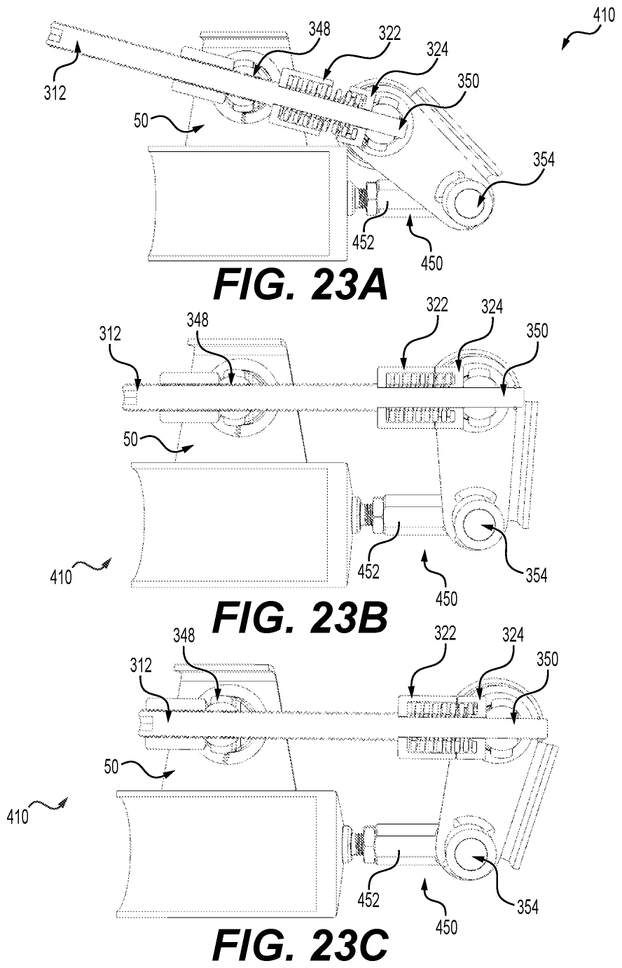

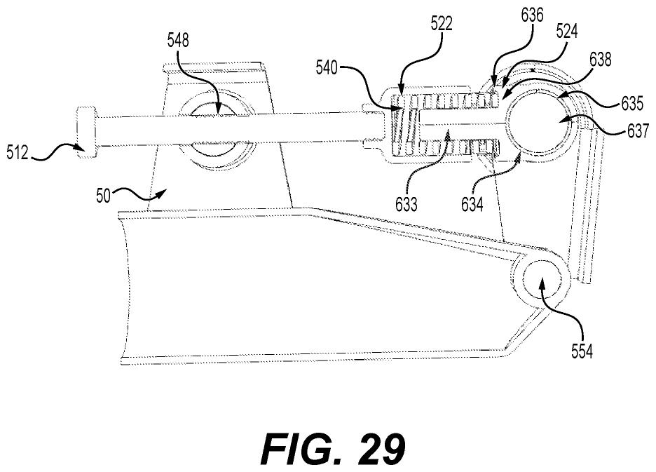

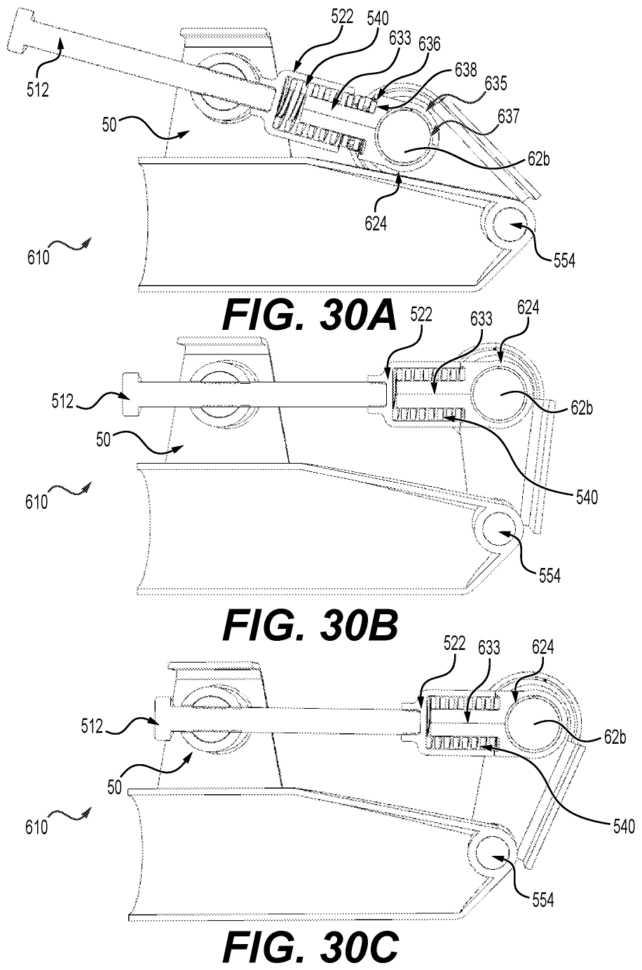

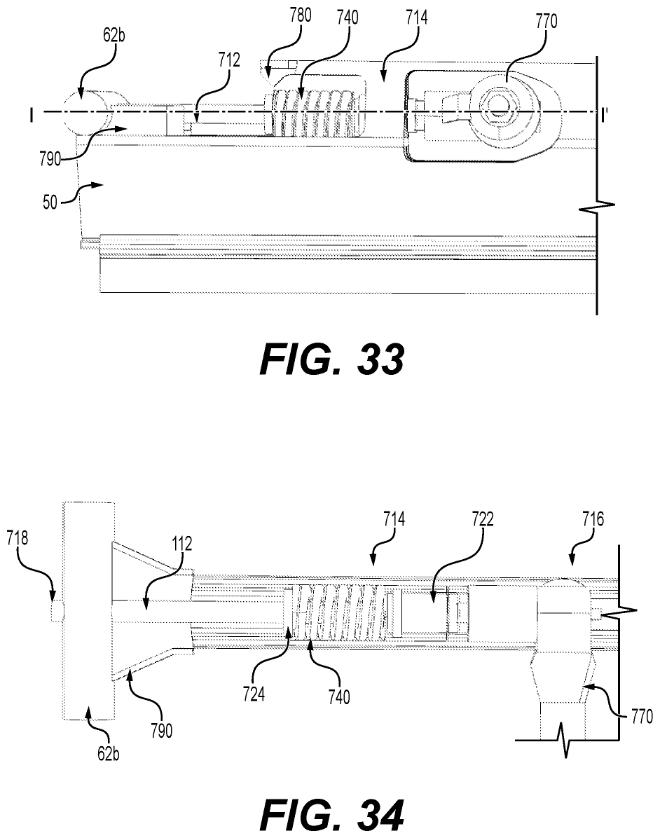

In some embodiments, at least one of the leading and trailing idler wheel assemblies 60a, 60b is connected to the lower frame member 56 via a tensioning assembly. The tensioning assembly is operable to adjust a tension in the endless track 70 by moving a given one or both of the leading and trailing idler wheel assemblies 60a, 60b toward or away from the frame 50. The tensioning assembly of the present technology can also provide an indication of when a predetermined tension is achieved, in manners that will be described with reference to the FIGS. 3 to 35.

The track system 20a also includes the endless track 70, which extends around components of the track system 20a, notably the frame 50, the leading and trailing idler wheel assemblies 60a, 60b and the support wheel assemblies 100a, 100b, 100c. The endless track 70 has the inner surface 72 and an outer surface 74. The inner surface 72 of endless track 70 has lugs 76 (shown in FIG. 2). The lugs 76 are adapted to engage with the engaging members 44 of the sprocket wheel assembly 40. As mentioned previously, other engagement configurations between the sprocket wheel assembly 40 and the endless track 70 are contemplated as well. The outer surface 74 of the endless track 70 has a tread defined thereon. It is contemplated that the tread could vary from one embodiment to another. In some embodiments, the tread could depend on the type of vehicle 10 on which the track system 20a is to be used and/or the type of ground surface on which the vehicle is destined to travel. In the present embodiment, the endless track 70 is an elastomeric endless track. Specifically, the endless track 70 is a polymeric endless track. It is contemplated that in some embodiments, the endless track 70 could be constructed of a wide variety of materials and structures.

### Tensioning Assembly

Broadly, embodiments of the tensioning assembly provide an adjustable resilient connection between a wheel axle, such as the wheel axle 62b of the trailing idler wheel assembly 60b of the track system 20a, and a mechanism to modulate a distance between the wheel axle 62b and the frame 50 of the track system 20a in order to obtain the predetermined tension in the endless track 70. According to embodiments of the present technology, the tensioning assembly comprises an indicator, which can be one or both of a visual and a tactile indictor, to indicate to a user of the tensioning assembly, whether the endless track 70 has the predetermined tension. Advantageously, the indicator can provide the indication of the tension without requiring any disassembly of the track system 20a.

The tensioning assembly 110 is described herein in relation to the frame 20a and the trailing idler wheel assembly 60b but can equally be connected to the frame 20b and/or the leading wheel assembly 60a.

### Embodiment 1

Referring now to FIGS. 3 to 7, a first embodiment of the tensioning assembly 110 comprises a shaft 112 and a resilient assembly 114.

The shaft 112 is connected to the frame 50 of the track system 20a, such as the trailing frame member 54 or the lower frame member 56. The resilient assembly 114 is connected to the wheel axle 62b and operatively connected to the shaft 112 such that when the shaft 112 is rotated, the wheel axle 62b is caused to move relative to the frame 50 to modulate the tension in the endless track 70. A movement of the wheel axle 62b away from the endless track 70 and towards the frame 50 causes a decrease in the tension in the endless track 70, and a movement of the wheel axle 62b towards the endless track 70 and away from the frame 50 causes an increase in the tension in the endless track 70.

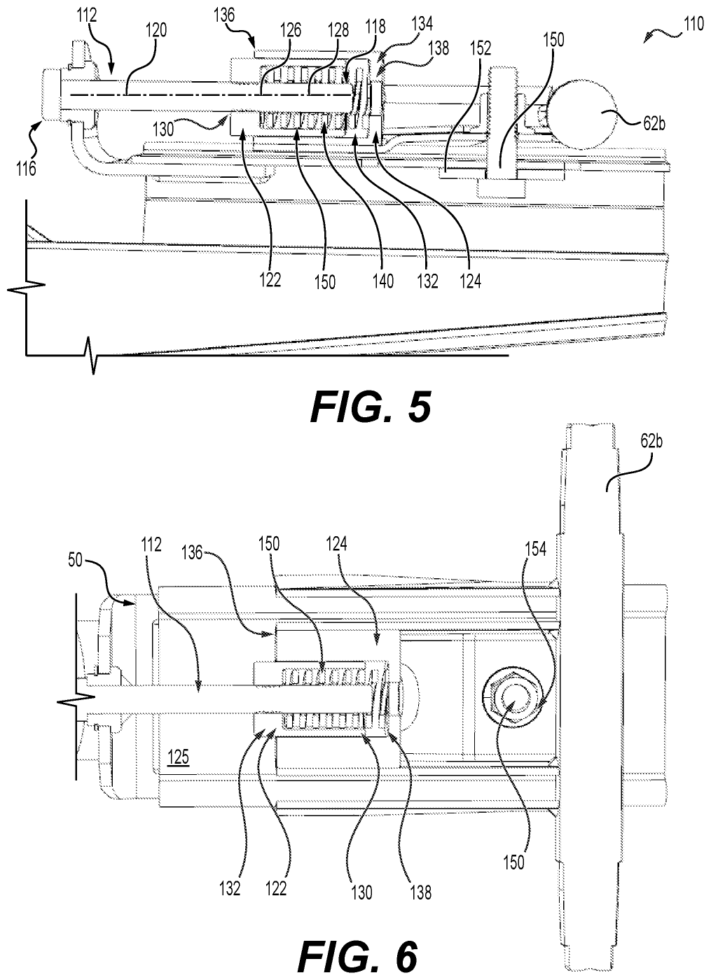

The shaft 112 has a connection end 116 and a free end 118 and is connected to the frame 50 at the connection end 116. As best seen in FIG. 5, the shaft 112 is elongate, having a longitudinal axis 120, and extends towards the wheel axle 62b from the connection end 116. The connection end 116 is shaped so that it can be manipulated by an appropriate tool to rotate the shaft 112 about its longitudinal axis 120. The shaft 112 is disposed relative to the frame 50 such that the connection end 116 can be readily accessed by a user to modulate the tension in the endless track 70 without having to dismantle any part of the vehicle 10. The connection end 116 is configured such that a tool can be readily attached thereto. The configuration of the connection end 116 nor the type of tool that can be used is limited. In certain embodiments, the connection end 116 is configured such that it can inter-engage with a socket and ratchet tool.

The shaft 112 and the wheel axle 62b are disposed on substantially the same plane. The longitudinal axis 120 of the shaft 112 and the wheel axle 62b are substantially transverse to one another.

The resilient assembly 114 is configured to convert rotational movement of the shaft 112 about the longitudinal axis 120 to a linear movement of the wheel axle 62b away or towards the endless track 70 and the frame 50.

As best seen in FIGS. 3 and 5, the resilient assembly 114 comprises a first member 122 threadedly connected to the shaft 112 and configured to be moved along the shaft 112 when the shaft 112 is rotated about its longitudinal axis 120. The resilient assembly 114 comprises a second member 124 which is connected to the wheel axle 62b. The second member 124 is connected to the first member 122 in a manner that permits relative movement of the first and second members 122, 124 when the shaft 112 is rotated about the longitudinal axis 120. The first and second members 122, 124 are slidingly engaged. The first member 122 at least partially nests within the second member 124.

As best seen in FIGS. 3 and 4, a portion of the frame 50 has a frame face 125 which is parallel to the longitudinal axis 120 of the shaft 112. The second member 124 has a frictional engagement with the frame face 125.

Movement of the first and second members 122, 124 are along respective planes parallel to the longitudinal axis 120 of the shaft 112. As best seen in FIG. 5, the first and second members 122, 124 have respective longitudinal axes 126, 128 which are parallel to one another as well as to the longitudinal axis 120 of the shaft 112.

As will be described later, under certain conditions, the first and second members 122, 124 move together as a unit relative to the shaft 112 along a plane parallel to the longitudinal axis 120 of the shaft 112.

A length of the shaft 112 is longer than a length of the first and second members 122, 124 respectively providing space for movement of the first and second members 122, 124 along the shaft 112.

The threaded connection of the first member 122 to the shaft comprises corresponding threads defined on corresponding portions of the shaft and the first member. The shaft 112 may be threaded along its entire length or a portion thereof.

As best seen in FIGS. 5 and 6, the first member 122 is substantially cylindrical and comprises a first member open end 130 and a first member base end 132. The second member 124 comprises a second member housing portion 134 which is also substantially cylindrical and comprises a second member housing open end 136 and a second member housing base end 138. The second member housing portion 134 is configured to house at least a portion of the first member 122 such that the first member 122 nests in the second member housing portion 134. The first member open end 130 is disposed in the second member housing portion 134. The first member base end 132 is oppositely facing the second member housing base end 138. The second member housing base end 138 has an opening formed therein.

A resilient member 140 is disposed in the first member 122 and resiliently biases the second member away 124 from the first member 122. The shaft free end 118 is disposed in the first member 122 and extends through the resilient member 140. The resilient member 140 is a spring having one end in contact with the first member base end 132 and another end in contact with an internal surface of the second member housing base end 138. The resilient member 140 is made of a material having stable mechanical properties (e.g., Young's Modulus, tension/compression properties) over a range of temperature of operation of the vehicle. The range of temperature over which the material is stable comprises about −40 degC to about 60 degC. In certain embodiments, the resilient member 140 is a spring made of steel. In certain other embodiments, the resilient member 140 is made from die steel, or a polymeric material such as polyurethane. In certain embodiments, the resilient member 140 is preloaded. The preloading may comprise a compression of the resilient member 140 up to more than about 80% of its total possible compression. In other embodiments, the preloading may comprise a compression of about 70%, 75%, 85% or 90% of its potential total compression. For example, in one embodiment, the resilient member 140 is a spring and has a total possible compression of 0.300 inches, and the preloading comprises a compression of 0.25 inches. By preloading the resilient member 140 in this manner, loss of tension or tooth skipping is reduced, minimized or avoided. The resilient member 140 need not be a spring and may have any other suitable configuration with stable and predictable elastic properties. In certain embodiments, the resilient member 140 comprises a belleville washer.

An indicator provides an indication when the wheel axle 62b is in a predetermined position corresponding to a predetermined tension in the endless track 70. A user can be informed by the indicator of the predetermined tension in the endless track 70 being reached without having to disassemble parts of the track system 20a or the vehicle 10.

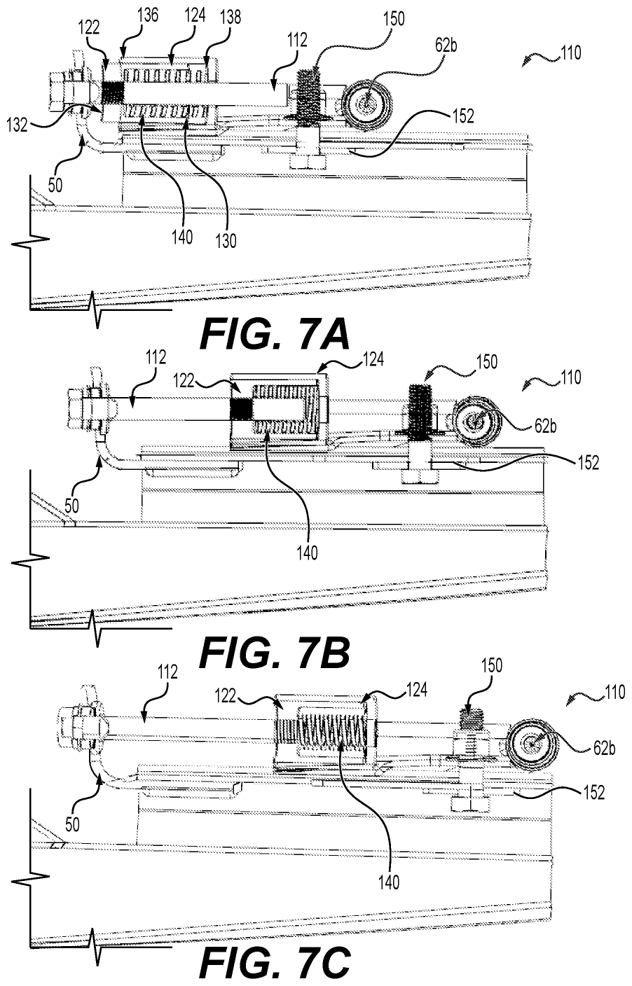

As illustrated in FIG. 7B, the indicator comprises a “hard stop” of a relative movement of the first and second members 122, 124 to each other when the shaft 112 is being rotated about its longitudinal axis 120. In this respect, the indicator is a tactile indicator which the user will feel as they rotate the shaft 112 using a tool at the connection end 116. The first and second members 122, 124 are sized and shaped such that the first member open end 130 can abut the internal surface of the second member housing base end 138 when the shaft 112 is rotated about its longitudinal axis 120. When the first member open end 130 abuts the internal surface of the second member housing base end 138, a relative position of the first and second and second members 122, 124 to each other causes the wheel axle 62b to assume the predetermined position relative to the frame 50 and the endless track 70 to impart the predetermined tension on the endless track 70. As the first member open end 130 approaches the internal surface of the second member housing base end 138, the resilient member 140 is compressed thereby providing an increased resistance to turning of the shaft 112 closer to the predetermined position, which provides a further tactile indication.

The indicator also comprises a visual indication that the predetermined tension in the endless track 70 has been reached. In this respect, the first and second members 122, 124 are sized and shaped such that the first member base end 132 is flush (aligned) with the second member housing open end 136 when the first member open end 130 abuts the internal surface of the second member housing base end 138. Alternatively, the visual indication may comprise any other alignment between the first and second members 122, 124 which can be determined visually. For example, the visual indication may comprise a predetermined spacing between the first member base end 132 and the second member housing open end 136. One or more markings may be provided on any of the first member 122, the second member 124, the shaft 112 or the frame 50 as the visual indication.

It will be appreciated that in certain other embodiments (not shown), the indicator comprises the visual indication without the “hard stop”. In other words, the first and second members 122, 124 are sized and shaped such that the first member base end 132 is flush with the second member housing open end 136 when the predetermined wheel axle 62b position, and hence the predetermined tension in the endless track 70, is attained without the first member open end 130 abutting the internal surface of the second member housing base end 138.

In addition to, or instead of, the abovementioned indicators, a further indication can be provided based on a predetermined assembled position of the first member 122 and/or the second member 124 relative to the frame 50. In this respect, the indicator may comprise a mark 142 on the frame face, an alignment of the first and/or second member 122, 124 with the mark 142 indicating the predetermined assembly position. In certain embodiments, the indication is a distance between two parts of the resilient member 140, for example a distance between two coils of a spring when the resilient assembly 140 is a spring. In this respect, a tool may be provided for verifying a distance between the two parts, such as a gage. If the gage does not fit between the two parts then this would indicate that the resilient member 140 is too compressed, and if the gage is too loose between the two parts then this is an indication that the resilient member 140 is not compressed sufficient (insufficient tension).

Referring now to FIG. 4, the second member 124 further comprises a second member plate portion 144 extending from the second member housing portion 134. The second member plate portion 144 is parallel to the frame face 125 and has frictional engagement therewith. The second member plate portion 144 is disposed beneath the second member housing portion 134 and connected thereto. The second member 124 terminates in a cylindrical housing in which the wheel axle 62b is rotationally disposed.

The second member 124 further comprises a pair of second member wing portions 146 respectively extending from either side of the second member plate portion 144. The second member wing portions 146 are configured such that applying a force on the second member 124, such as on the second member wing portions 146, towards the frame face 125 can increase the frictional engagement between the second member 124 and the frame 50. Such an increase in the frictional engagement can help to maintain a relative position of the wheel axle 62b to the endless track 70, hence maintaining the predetermined tension in use.

More specifically, each second member wing portion 146 corresponds substantially in profile to a frame ridge 148, there being provided a pair of frame ridges 148 each extending along a respective side of the frame face 125. Portions of the second member wing portions 146 are spaced above the frame face 125 and are brought into contact with the frame ridges 148 when force is applied downwardly to the second member wing portions 146. It will be appreciated that the second member wing portion 146 may be configured in any other manner that would permit a frictional engagement of the second member 124 to the frame 50 to be modulated.

The resilient assembly 114 further comprises a guide assembly 149 to guide a movement of one or both of the first and second members 122, 124 relative to the frame 50. The guide assembly comprises a pin 150 extending through the frame face 125 and connected to the second member 124 in a direction transversely to the frame face 125, and a slot 152 defined in the frame face 125 along which the pin 150 can slide to thereby the guide the movement of one or both of the first and second members 122, 124. The pin 150 is connected to the second member plate portion 144 by a nut 154. Tightening the nut 154 can apply the downward force on the second member 124 to increase the frictional engagement. In some cases, such as when a static tensioner is desired, the nut 154 can be tightened so as to impede movement of the resilient member 140 relative to the frame 50.

A mode of operation of the tensioning assembly 110 will now be described with specific reference to FIGS. 7A, 7B and 7C. The resilient assembly 114 is configured to move between a retracted position (FIG. 7A), a neutral position (FIG. 7B) and a deployed position (FIG. 7C). The tension in the endless track 70 is higher when the tensioning assembly 114 is in the deployed position compared to the neutral and retracted positions. The deployed position of the resilient assembly 114 is utilized when the vehicle 10 is in operation (moving), and the retracted position is utilized for removing and installing the endless track 70 from the vehicle 10 for instance.

The first and second members 122, 124 have a predetermined position relative to each other, as well as having a predetermined positioned relative to the shaft 112 for each of the retracted, neutral and deployed positions. The resilient assembly 114 is positioned closer to the connection end 116 of the shaft 112 in the retracted position compared to the deployed position. The second member 124 is positioned closer to the endless track 70 in the deployed position compared to the retracted position. In this respect, in the retracted position, a pressure that the trailing idler wheel assembly 60b applies to the inner surface of the endless track 70 is decreased such that a significant portion of the tension within the endless track 70 is released. In some embodiments, the trailing idler wheel assembly 60b may or may not retain its contact with the endless track 70. Whereas in the deployed position, the trailing idler wheel assembly 60b is in contact with the endless track 70 in order to induce the predetermined tension therein.

In use, starting from the neutral position (FIG. 7B), the retracted position is assumed when the shaft 112 is rotated about the longitudinal axis 120 in a first direction, the first member 122 is brought closer to the connection end 116 of the shaft 112. In turn, the second member 124 is also caused to move with the first member 122 as a friction between the first and second members 122, 124 is more than a friction between the second member 124 and the frame face 125. Due to the resilient member 140, the first and second members are not fully nested, and the first member base end 132 is spaced from the second member housing open end 136. As the second member 124 is connected to the wheel axle 62b by the second member plate portion 144, the wheel axle 62b is also moved towards the connection end 116 of the shaft 112 and away from the endless track 70. Tension in the endless track 70 is thus decreased.

To increase the tension in the endless track, whether from the neutral position or the retracted position, the shaft 112 is rotated about the longitudinal axis 120 in a second direction which is opposite to the first direction, the rotation of the shaft 112 translating the first member 122 away from the connection end 116 of the shaft 112 and towards the free end 118 of the shaft 112. In turn, the second member 124 is also caused to move with the first member 122 in a same direction. As the second member 124 is connected to the wheel axle 62b by the second member plate portion 144, the wheel axle 62b is also moved away from the connection end 116 of the shaft 112 and towards the endless track 70. The movement of the second member 124 is guided by the pin 150 moving in the slot 152.

When the trailing idler wheel assembly 60b contacts the endless track 70, there is an increased resistance to further movement of the second member 124 away from the connection end 116 of the shaft 112. Further rotation of the shaft 112 about the longitudinal axis 120 in the second direction therefore causes the first member 122 to move towards the second member 124 and nest more completely within the second member 124. As the first and second members 122, 124 are brought closer together, the resilient member 140 compresses and the resistance to further rotation of the shaft 112 further increases.

The deployed position is reached when the indicator indicates one or more of the “hard stop” and/or the visual indicators. It is understood that the indicator can be configured to indicate different positions (e.g. retracted, neutral, deployed and/or any intermediate position therebetween) as required. In addition, the indicator can be adapted to provide one or more of visual and/or “hard stop” indicators for a given model of track system (i.e. specific indicator for a specific track system) or more than one track system (i.e. a generic indicator for multiple track systems).

The deployed position can be maintained, and hence the tension in the endless track 70 maintained, by applying a force to the second member 124 to increase a friction contact between the second member 124 and the frame face 125. The force may be applied by tightening the nut 154 around the pin 150 which is positioned above second member plate portion 146 to bring the second member wing portion 146 closer to the frame face 125. Force may be applied in any other manner.

In order to remove the endless track 70 from the track system 20a, the steps outlined above may be reversed in order to modulate the tensioning assembly 110 from the deployed position to the retracted position.

### Embodiment 2

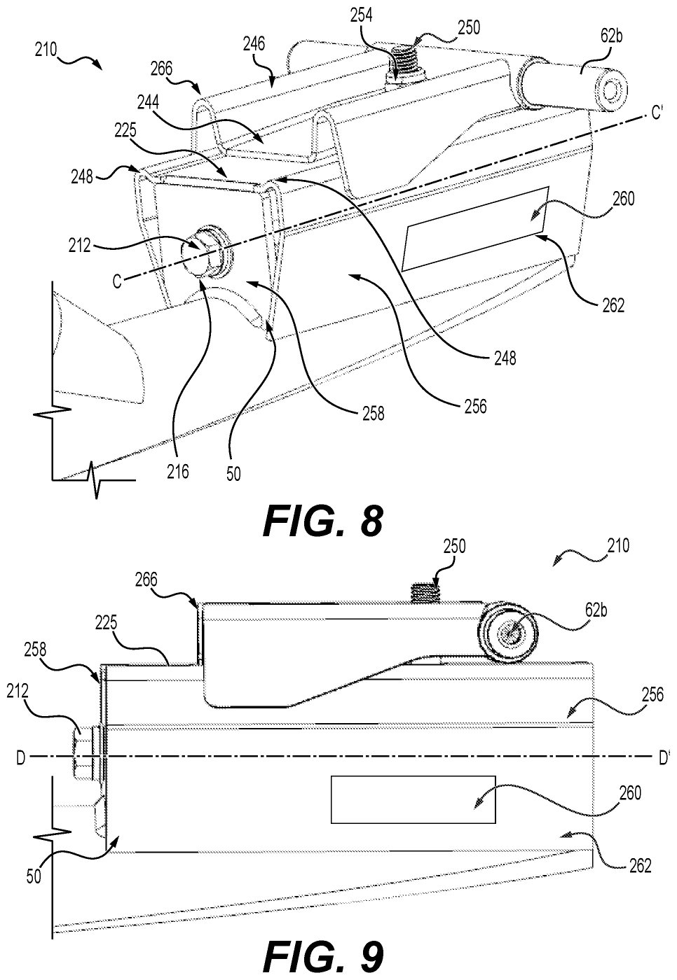

A tensioning assembly 210 according to another embodiment of the present technology will now be described with reference to FIGS. 8 to 12. The tensioning assembly 210 differs from the tensioning assembly 110 in a positioning of the first and second members 122, 124 relative to the wheel axle 62b and the shaft 112.

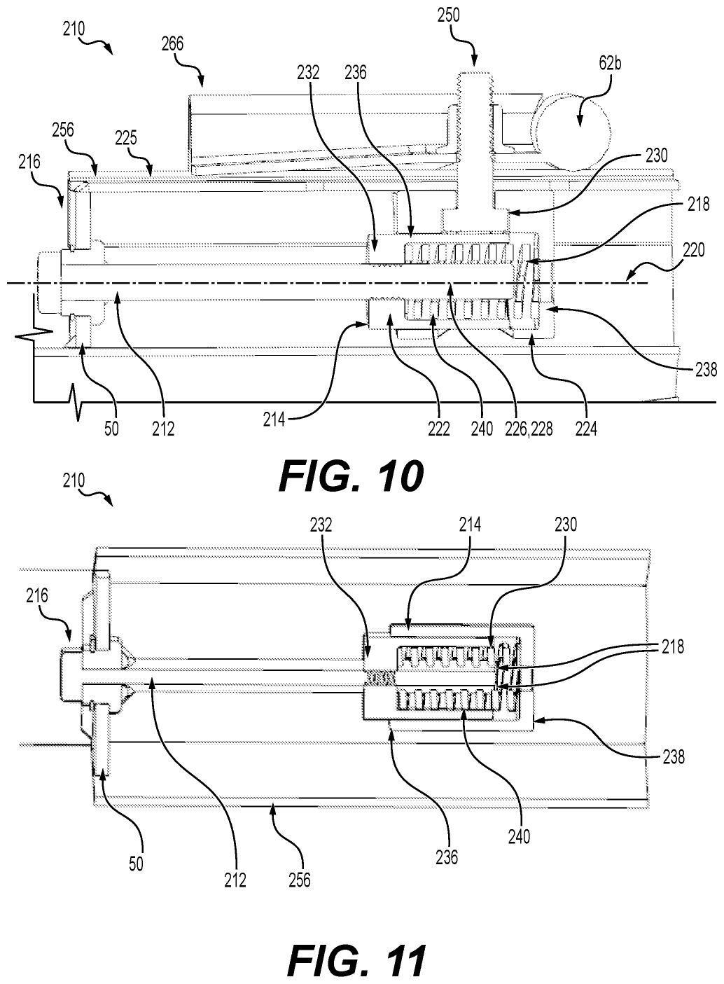

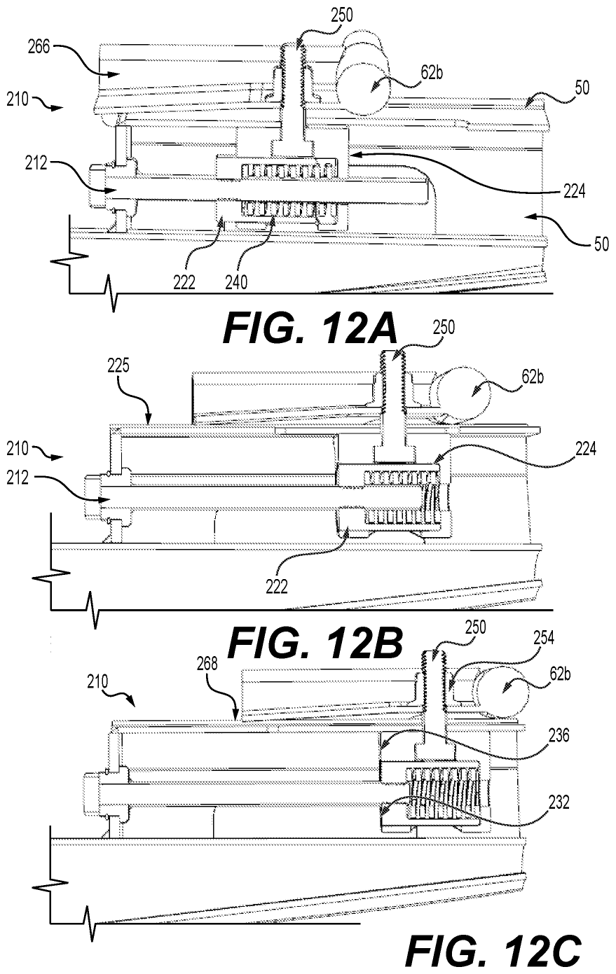

As best seen in FIGS. 10 and 11, the tensioning assembly 210 comprises a shaft 212 and a resilient assembly 214. The shaft 212 is connected to the frame 50 of the track system 20a. The resilient assembly 214 is connected to the wheel axle 62b and operatively connected to the shaft 212 such that when the shaft 212 is rotated, the wheel axle 62b is caused to move relative to the frame 50 to modulate the tension in the endless track 70. A movement of the wheel axle 62b away from the endless track 70 and towards the frame 50 causes a decrease in the tension in the endless track 70, and a movement of the wheel axle 62b towards the endless track 70 and further from the frame 50 causes an increase in the tension in the endless track 70.

The shaft 212 has a connection end 216 and a free end 218 and is connected to the frame 50 at the connection end 216. The shaft 212 is elongate, having a longitudinal axis 220, and extends towards the wheel axle 62b from the connection end 216. The connection end 216 is shaped so that it can be manipulated by an appropriate tool to rotate the shaft 212 about its longitudinal axis 220. The shaft 212 is disposed relative to the frame 50 such that the connection end 216 can be readily accessed by a user to modulate the tension in the endless track 70 without having to dismantle any part of the vehicle 10. The connection end 216 is configured such that a tool can be readily attached thereto. The configuration of the connection end 216 nor the type of tool that can be used is limited. In certain embodiments, the connection end 216 is configured such that it can inter-engage with a socket and ratchet tool.

Unlike the tensioning assembly 110 of FIGS. 3 to 7, in the tensioning assembly 210 of FIGS. 8 to 12, the shaft 212 and the wheel axle 62b are disposed on different planes. The longitudinal axis 220 of the shaft 220 and the wheel axle 62b are substantially transverse to one another.

The resilient assembly 214 comprises a first member 222 threadedly connected to the shaft 212 and configured to be moved along the shaft 212 when the shaft 212 is rotated. The resilient assembly 214 comprises a second member 224 which is connected to the wheel axle 62b. The second member 224 is also connected to the first member 222 in a manner that permits relative movement of the first and second members 222, 224 when the shaft 122 is rotated about the longitudinal axis 220. The first and second members 222, 224 are slidingly engaged. Movement of the first and second members 222, 224 are along respective planes parallel to the longitudinal axis 220 of the shaft 212. The first and second members 222, 224 have respective longitudinal axes 226, 228 which are parallel to one another as well as to the longitudinal axis 220 of the shaft 212. A length of the shaft 212 is longer than a length of the first and second members 222, 224 respectively providing space for movement of the first and second members 222, 224 along the shaft 212.

The threaded connection of the first member 222 to the shaft comprises corresponding threads defined on corresponding portions of the shaft 212 and the first member 222. The shaft 212 may be threaded along its entire length or a portion thereof.

The first member 222 is substantially cylindrical and comprises a first member open end 230 and a first member base end 232. The second member 224 is also substantially cylindrical and comprises a second member open end 236 and a second member base end 238. The second member 224 is configured to house at least a portion of the first member 222 such that the first member 222 nests in the second member 224. The first member open end 230 is disposed in the second member 224. The first member base end 232 is oppositely facing the second member base end 238. The second member base end 238 has an opening formed therein.

A resilient member 240 is disposed in the first member 222 and resiliently biases the second member 224 away from the first member 222. The shaft free end 218 is disposed in the first member 222 and extends through the resilient member 240. The resilient member 240 is a spring having one end in contact with the first member base end 232 and another end in contact with an internal surface of the second member base end 238. The resilient member 240 is made of a material having stable mechanical properties (e.g. Young's Modulus, tension/compression properties) over a range of temperature of operation of the vehicle. The resilient member 240 need not be a spring and may have any other suitable configuration with stable and predictable elastic properties. In certain embodiments, the resilient member 240 comprises a belleville washer. The range of temperature over which the material is stable comprises about −40 degC to about 60 degC. In certain embodiments, the resilient member 240 is a spring made of steel. In certain other embodiments, the resilient member 240 is made from die steel, or a polymeric material such as polyurethane. In certain embodiments, the resilient member 240 is preloaded. The preloading may comprise a compression of the resilient member 240 up to more than about 80% of its total possible compression. In other embodiments, the preloading may comprise a compression of about 70%, 75%, 85% or 90% of its potential total compression. For example, in one embodiment, the resilient member 240 is a spring and has a total possible compression of 0.300 inches, and the preloading comprises a compression of 0.25 inches. By preloading the resilient member 240 in this manner, loss of tension or tooth skipping is reduced, minimized or avoided.

A portion of the frame 50 has a frame face 225 which is parallel to the longitudinal axis 220 of the shaft 212. Unlike the tensioning assembly 110 of FIGS. 3 to 7, in the tensioning assembly 210 of FIGS. 8 to 12, the resilient assembly 214 is positioned below the frame face 225, and the wheel axle 62b is positioned above the frame face 225. The frame face 225 separates the resilient assembly 214 from the wheel axle 62b. The wheel axle 62b is disposed above the resilient assembly 214 in the vehicle 10. The second member 224 has a frictional engagement with an underside of the frame face 125.

As best seen in FIGS. 8 and 9, the resilient assembly 214 is disposed in a housing 256 below the frame face 225. The housing 256 has an end wall 258 through which the shaft 212 extends, such that the connection end 216 of the shaft 212 is disposed outside of the housing 256 permitting access to the connection end 216 by the user for manipulation by the tool, for example. An opening 260 is provided in a side wall 262 of the housing 256 to permit the user to view the resilient assembly 214 therein, for visual indication of the predetermined tension.

A sliding member 266 is provided above the frame face 225. The sliding member 266 comprises a sliding member plate portion 244 and a sliding member wing portion 246 extending from either side of the second member plate portion 244, having a configuration somewhat resembling that of the second member plate portion 144 and the second member wing portion 146 of FIGS. 3 to 7. At least the sliding member plate portion 244 of the sliding member 266 is in frictional engagement with an upper side of the frame face 225. The sliding member wing portions 246 are configured such that applying a force on the sliding member 266 towards the frame face 125 increases the frictional engagement between the sliding member 266 and the frame 50 to help to maintain a relative position of the wheel axle 62b to the endless track 70, hence maintaining the predetermined tension in use.

As best seen in FIG. 8, each sliding member wing portion 246 corresponds substantially in profile to a frame ridge 248 of the housing 256, there being provided a pair of frame ridges 248 each extending along a respective side of the frame face 225. The sliding member wing portions 246 are spaced above the frame face 225 and are brought into contact with the frame ridges 248 when the force is applied downwardly to the sliding member 266. It will be appreciated that the sliding member wing portion 246 may be configured in any other manner that would permit modulation of a frictional engagement of the sliding member 266 with the frame 50.

The sliding member 266 is connected to the wheel axle 62b. A pin 250 extends from the resilient assembly 214 through the frame face 225, and is connected to the sliding member 266, to connect the resilient assembly 214 to the wheel axle 62b. The pin 250 extends transversely to the longitudinal axis 220 of the shaft 212. The pin 250 extends from an interface of the first member 222 and the second member 224, through the second member 224, and has a frictional engagement with the first member 222.

An indicator provides an indication when the wheel axle 62b is in a predetermined position corresponding to a predetermined tension in the endless track 70. A user can be informed by the indicator of the predetermined tension in the endless track 70 being reached without having to disassemble parts of the track system 20a or the vehicle 10.

As illustrated in FIGS. 8 to 12, the indicator comprises a tactile indication in the form of a “hard stop” of a relative movement of the first and second members 222, 224 to each other when the shaft 212 is being rotated about its longitudinal axis 220. In this respect, the indicator is a tactile indicator which the user will feel as they rotate the shaft 212 using the tool at the connection end 216. The first and second members 222, 224 are sized and shaped such that the first member open end 230 can abut the internal surface of the second member base end 238 when the shaft 212 is rotated about its longitudinal axis 220. When the first member open end 230 abuts the internal surface of the second member base end 238, a relative position of the first and second and second members 222, 224 to each other causes the wheel axle 62b to assume the predetermined position relative to the frame 50 and the endless track 70 so as to impart the predetermined tension on the endless track 70. As the first member open end 230 approaches the internal surface of the second member base end 238, the resilient member 240 is compressed thereby providing an increased resistance to turning of the shaft 212 closer to the predetermined position, which provides a further tactile indication.

In the embodiment of FIGS. 8 to 12, the indicator also comprises a visual indication that the predetermined tension in the endless track 70 has been reached. In this respect, as best seen in FIG. 12C, the visual indication is a mark 268 on the frame face 225 which indicates that the predetermined tension has been achieved when an edge of the sliding member 266 is aligned with the mark 268.

Another visual indication is provided by an alignment of the first and second members 222, 224. Specifically, the first and second members 222, 224 are sized and shaped such that the first member base end 232 is flush (aligned) with the second member open end 236 when the first member open end 230 abuts the internal surface of the second member base end 238. The opening 260 in the side wall 262 of the housing 256 permits the user to see this visual indicator. Alternatively, the visual indication may comprise any other alignment between the first and second members 222, 224 which can be determined visually. For example, the visual indication may comprise a predetermined spacing between the first member base end 232 and the second member open end 236.

It will be appreciated that in other embodiments, the indicator may comprise any one or more of the visual and tactile indicators described above. For example, the indicator may comprise the visual indication without the “hard stop”. In this respect, the first and second members 222, 224 are sized and shaped such that the first member base end 232 is flush with the second member open end 236, and the edge of the sliding member 266 aligns with the mark 268 when the predetermined tension is attained without the first member open end 230 abutting the internal surface of the second member base end 238.

In certain embodiments, the indication is a distance between two parts of the resilient member 240, for example a distance between two coils of a spring when the resilient assembly 240 is a spring. In this respect, a tool may be provided for verifying a distance between the two parts, such as a gage.

A mode of operation of the tensioning assembly 210 will now be described with specific reference to FIGS. 12A, 12B and 12C. The resilient assembly 214 is configured to move between a retracted position (FIG. 12A), a neutral position (FIG. 12B) and a deployed position (FIG. 12C). The tension in the endless track 70 is higher when the tensioning assembly 214 is in the deployed position compared to the neutral and retracted positions. The deployed position of the resilient assembly 214 is utilized when the vehicle 10 is in operation (moving), and the retracted position is utilized for removing and installing the endless track 70 from the vehicle 10.

The first and second members 222, 224 have a predetermined position relative to each other, as well as having a predetermined positioned relative to the shaft 212 in the deployed position. The resilient assembly 214 is positioned closer to the connection end 216 of the shaft 212 in the retracted position compared to the deployed position. The second member 224 is positioned closer to the endless track 70 in the deployed position compared to the retracted position. In this respect, in the retracted position, a pressure that the trailing idler wheel assembly 60b applies to the inner surface of the endless track 70 is decreased such that a significant portion of the tension within the endless track 70 is released. In some embodiments, the trailing idler wheel assembly 60b may or may not retain its contact with the endless track 70. Whereas in the deployed position, the trailing idler wheel assembly 60b is in contact with the endless track 70 in order to induce the predetermined tension therein.

In use, starting from the neutral position (FIG. 12B), the retracted position is assumed when the shaft 212 is rotated about the longitudinal axis 220 in a first direction, and the first member 222 is brought closer to the connection end 216 of the shaft 212. As the first and second members 222, 224 are caused to move, the pin 250 is also caused to move hence also moving the sliding member 266 and the wheel axle 62b. Due to the resilient member 240, the first and second members 222, 224 are not fully nested, and the first member base end 232 is spaced from the second member open end 236. As the second member 124 is connected to the wheel axle 62b by the pin 250 and the sliding member 266, the wheel axle 62b is also moved towards the connection end 216 of the shaft 212 and away from the endless track 70. Tension in the endless track 70 is thus decreased.

To increase the tension in the endless track 70, whether from the neutral position or from the retracted position, the shaft 212 is rotated about the longitudinal axis 220 in a second direction which is opposite to the first direction, the rotation of the shaft 212 translating the first member 222 away from the connection end 216 of the shaft 212 and towards the free end 218 of the shaft 212. In turn, the second member 224 is also caused to move with the first member 222 in a same direction. As the second member 224 is connected to the wheel axle 62b by the sliding member 266 and the pin 250, the wheel axle 62b is also moved away from the connection end 216 of the shaft 212 and towards the endless track 70.

When the trailing idler wheel assembly 60b contacts the endless track 70, there is an increased resistance to further movement of the second member 224 away from the connection end 216 of the shaft 212. Further rotation of the shaft 212 about the longitudinal axis 220 in the second direction therefore causes the first member 222 to move towards the second member 224 and nest more completely within the second member 224. As the first and second members 222, 224 are brought closer together, the resilient member 240 compresses and the resistance to further rotation of the shaft 212 further increases.

The deployed position of FIG. 12C is reached when the indicator indicates one or more of the “hard stop” and/or the visual indicators. It is understood that the indicator can be configured to indicate different positions (e.g. retracted, neutral, deployed and/or any intermediate position therebetween) as required. In addition, the indicator can be adapted to provide one or more of visual and/or “hard stop” indicators for a given model of track system (i.e. specific indicator for a specific track system) or more than one track system (i.e. a generic indicator for multiple track systems).

The deployed position can be maintained, and hence the tension in the endless track 70 maintained, by applying a force to the sliding member 266 to increase a friction contact between the sliding member 266 and the frame face 225. The force may be applied by tightening a nut 254 around the pin 150 which is positioned above the sliding member plate portion 244 to bring the sliding member wing portion 246 closer to the frame face 225. Force may be applied in any other manner.

In order to remove the endless track 70 from the track system 20a, the steps outlined above may be reversed in order to modulate the tensioning assembly 210 from the deployed position to the retracted position.

### Embodiment 3

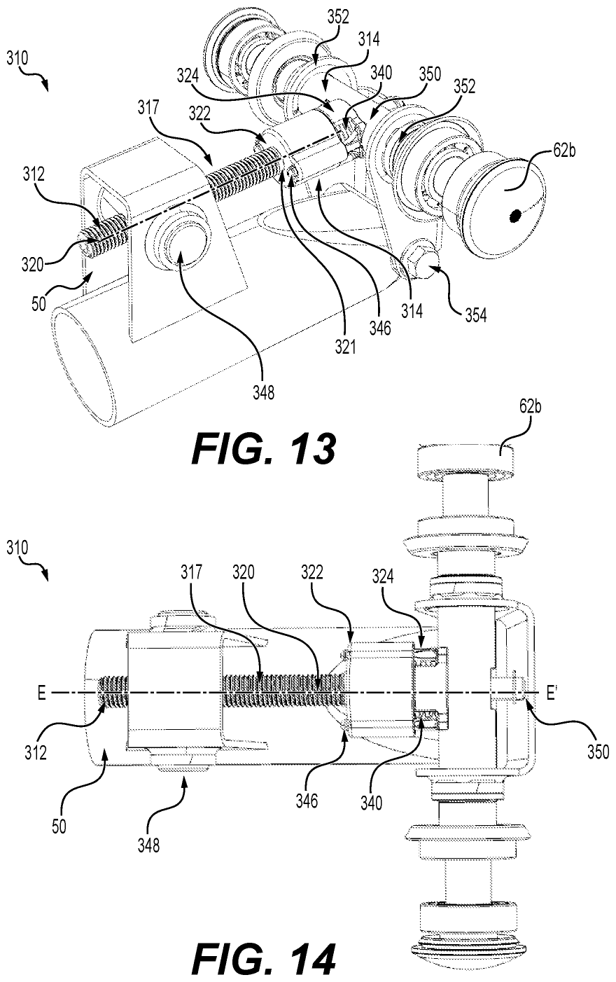

A tensioning assembly 310 according to another embodiment of the present technology will now be described with reference to FIGS. 13 to 18.

The tensioning assembly 310 comprises a shaft 312 and a resilient assembly 314. The shaft 312 is connected to the frame 50 of the track system 20a, such as the trailing frame member 54 or the lower frame member 56. The shaft has a longitudinal axis 320. The resilient assembly 114 is connected to the wheel axle 62b and operatively connected to the shaft 112 such that when the shaft 112 is rotated, the wheel axle 62b is caused to move relative to the frame 50 to modulate the tension in the endless track 70. A movement of the wheel axle 62b away from the endless track 70 and towards the frame 50 causes a decrease in the tension in the endless track 70, and a movement of the wheel axle 62b towards the endless track 70 and away from the frame 50 causes an increase in the tension in the endless track 70.

The embodiment of FIGS. 13 to 16 differs from that of FIGS. 1 to 7 in the shaft 312 is threadedly connected to the frame 50 such that rotation of the shaft 312 about the longitudinal axis 320 causes the shaft 312 to move laterally with respect to the frame 50. This lateral movement of the shaft 312 causes the movement of the resilient assembly 314 and hence the wheel axle 62b.

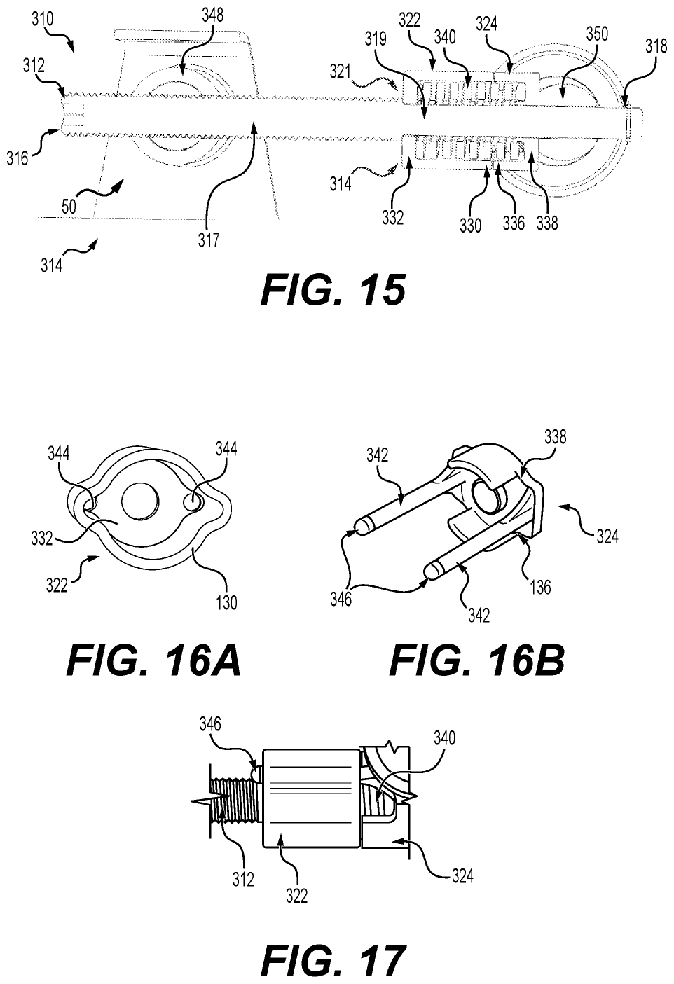

Referring to FIG. 15, the shaft 312 has a connection end 316 and a free end 318, and is connected to the frame 50 at the connection end 316. The shaft 312 is elongate and extends towards the wheel axle 62b from the connection end 316. The connection end 316 is shaped so that it can be manipulated by an appropriate tool to rotate the shaft 312 about its longitudinal axis 320. The shaft 312 is disposed relative to the frame 50 such that the connection end 316 can be readily accessed by a user to modulate the tension in the endless track 70 without having to dismantle any part of the vehicle 10. The connection end 316 is configured such that a tool can be readily attached thereto. The configuration of the connection end 316 nor the type of tool that can be used is limited. In certain embodiments, the connection end 316 is configured such that it can inter-engage with a socket and ratchet tool.

The free end 318 is connected to the wheel axle 62b. The shaft 312 comprises a threaded portion 317 and a non-threaded portion 319. The non-threaded portion 319 is closer to the free end 318 of the shaft 312.

The shaft 312 and the wheel axle 62b are disposed on substantially the same plane. The longitudinal axis 320 of the shaft 320 and the wheel axle 62b are substantially transverse to one another on the plane.

As best seen in FIG. 15, the resilient assembly 314 comprises a first member 322, a second member 324 and a resilient member 340. The shaft 312 extends through the first member 322, the second member 324 and the resilient member 340. The resilient assembly 314 is disposed at the non-threaded portion 319 of the shaft 312. The first member 322, the second member 324 and the resilient member 340 are all slidingly moveable along the shaft 312 in a direction parallel to the longitudinal axis 320. The resilient member 340 resiliently biases the first and second members 322, 324 away from each other. A length of the non-threaded portion 319 of the shaft 312 is longer than a length of the first and second members 322, 324 respectively providing space for translation of the first and second members 322, 324 along the shaft 312.

The resilient assembly 314 includes a first delimiting member 321 on the shaft 312 which delimits the movement of the first member 322 along the shaft in a direction away from the wheel axle 62b (and towards the connection end 316 of the shaft 312). The delimiting member 321 functions as a stopper. The delimiting member 321 may be configured as a lip or a shoulder extending from the shaft 312.

Still referring to FIG. 15, the first member 322 is substantially cylindrical and comprises a first member open end 330 and a first member base end 332. The second member 324 comprises a second member open end 336 and a second member base end 338. The first and second members 322, 324 are disposed in a side-by-side configuration along the shaft 312 with the first member open end 330 facing the second member open end 336. Both the first and second member base ends 332, 338 have respective openings formed therein for the shaft 312 to extend therethrough.

Each of the first member 322 and the second member 324 house a respective end of the resilient member 340. The resilient member 340 resiliently biases the first and second members 322, 324 apart. The resilient member 340 is a spring having one end in contact with the first member base end 332 and another end in contact with the second member base end 338. The resilient member 340 is made of a material having stable mechanical properties (e.g. Young's Modulus, tension/compression properties) over a range of temperature of operation of the vehicle. The range of temperature over which the material is stable comprises about −40 degC to about 60 degC. In certain embodiments, the resilient member 340 is a spring made of steel. In certain other embodiments, the resilient member 340 is made from die steel, or a polymeric material such as polyurethane. In certain embodiments, the resilient member 340 is preloaded. The preloading may comprise a compression of the resilient member 340 up to more than about 80% of its total possible compression. In other embodiments, the preloading may comprise a compression of about 70%, 75%, 85% or 90% of its potential total compression. For example, in one embodiment, the resilient member 340 is a spring and has a total possible compression of 0.300 inches, and the preloading comprises a compression of 0.25 inches. By preloading the resilient member 340 in this manner, loss of tension or tooth skipping is reduced, minimized or avoided. The resilient member 340 need not be a spring and may have any other suitable configuration with stable and predictable elastic properties. In certain embodiments, the resilient member 340 comprises a belleville washer. The resilient member 340 has a length which is modulated responsive to the relative movement of the first and second members 322, 324 when the shaft 312 is rotated about its longitudinal axis 320, wherein the length is selected such that the resilient member 340 is compressed when the first member 322 and the second member 324 are in the predetermined position.

Similar to the earlier described embodiments, the predetermined position of the wheel axle 62b corresponds to the predetermined tension in the endless track 70. An indicator provides an indication when the wheel axle 62b is in the predetermined position. The indication is based on one or both of (i) a predetermined position of the shaft 312 relative to the frame 50, and (ii) a predetermined relative position of the first and second members 322, 324. A user can be informed by the indicator of the predetermined tension in the endless track 70 being reached without having to disassemble parts of the track system 20a or the vehicle 10.

The indicator comprises a visual indication that the predetermined tension in the endless track 70 has been reached. In this respect, the first and second members 322, 324 are sized and shaped such that the first member open end 330 abuts the second member open end 336 when the wheel axle 62b is in the predetermined position. Alternatively, the visual indication may comprise any other relative position (i.e., spacing) between the first and second members 322, 324 which can be determined visually. For example, the visual indication may comprise a predetermined spacing between the first member base end and the second member open end 336. One or more markings (not shown) may be provided on any of the first member 322, the second member 324, the shaft 312 or the frame 50 as the visual indication.

As best seen in FIGS. 16 and 17, a further visual indication may be provided to indicate that the predetermined tension has been attained. In this respect, the second member 324 comprises a pair of elongate members 342 extending away from the second member base end 338. A pair of side openings 344 are provided in the first member base end 332 for receiving the pair of elongate members 342. Each elongate member 342 has a tip 346 which is visible from outside the resilient assembly 314 when the first member 322 and the second member 324 are in the predetermined position. The tip 346 may extend external to the first member base end 332. The tip 346 may be coloured to enhance its visibility. A single elongate member 342 may be provided instead of a pair of elongate members 342. More than two elongate members 342 may be provided instead of a pair of elongate members 342.

The further visual indication may be useful for the user when a view of an alignment of the first and second member 322, 324 as a visual indicator is impaired or blocked. The further visual indication may also be used to validate the primary visual indication. It will be appreciated that the primary and further visual indicators may be reversed in certain embodiments or one of the visual indicators even omitted.

In certain embodiments, the indication is a distance between two parts of the resilient member 340, for example a distance between two coils of a spring when the resilient assembly 340 is a spring. In this respect, a tool may be provided for verifying a distance between the two parts, such as a gage.

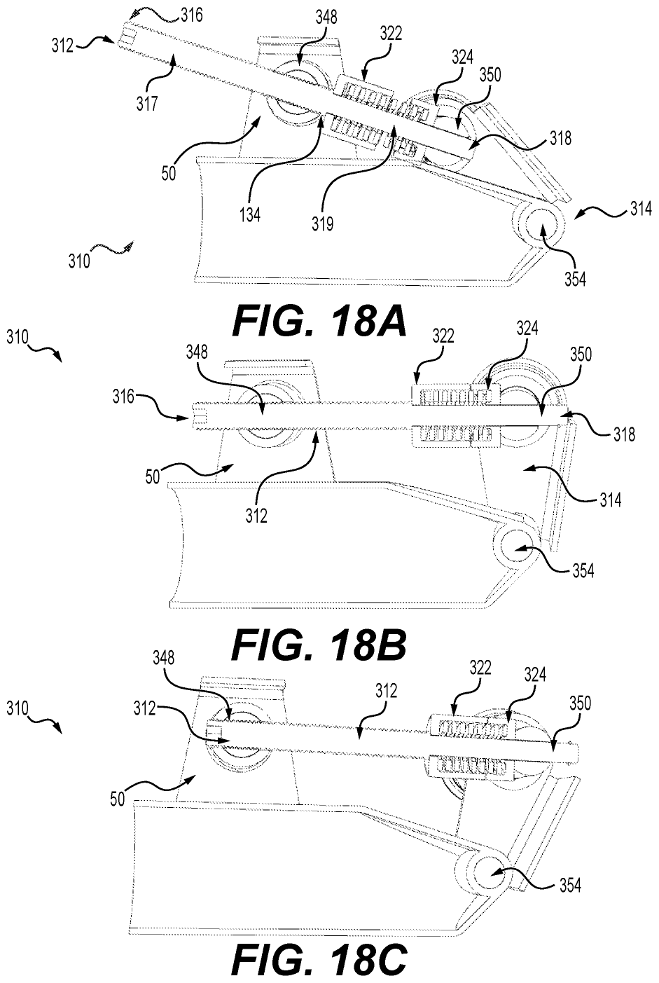

With reference now to FIG. 15, the shaft 312 is threadedly connected to the frame 50 at a first connection point 348 and is connected to the wheel axle 62b at a second connection point 350. The first connection point 348 comprises a pivotal connection between the frame 50 and the shaft 312, and the second connection point 350 comprises a pivotal connection between the wheel axle 62b and the shaft 312. As best seen in FIGS. 13 and 18, a third connection point 352 is provided between the wheel axle 62b and a fourth connection point 354. The fourth connection point 354 connects the frame 50 and the wheel axle 62b. The third and fourth connection points 352, 354 are pivotal connections. The third and fourth connection points 352, 354 may comprise a pair of third connection points 352 and a pair of fourth connection points 354 which are disposed one on either side of the shaft 312. For ease of understanding, the description herein will refer to single connection points.

A mode of operation of the tensioning assembly 110 will now be described with specific reference to FIGS. 18A, 18B and 18C. The shaft 312 and the resilient assembly 314 are configured to move between a retracted position (FIG. 18A), a neutral position (FIG. 18B) and a deployed position (FIG. 18C). The tension in the endless track 70 is higher in the deployed position compared to the neutral and retracted positions. The deployed position is utilized when the vehicle 10 is in operation (moving), and the retracted position is utilized for removing and installing the endless track 70 from the vehicle 10.

The first and second members 322, 324 have a predetermined position relative to each other, as well as having a predetermined positioned relative to the shaft 312 for the deployed position. The resilient assembly 314 is positioned closer to the connection end 316 of the shaft 312 in the retracted position compared to the deployed position. The second member 324 is positioned closer to the endless track 70 in the deployed position compared to the retracted position. Similarly, the shaft 312 has a predetermined positioned relative to the frame 50 for the deployed position. In this respect, in the retracted position, a pressure that the trailing idler wheel assembly 60b applies to the inner surface of the endless track 70 is decreased such that a significant portion of the tension within the endless track 70 is released. In some embodiments, the trailing idler wheel assembly 60b may or may not retain its contact with the endless track 70. Whereas in the deployed position, the trailing idler wheel assembly 60b is in contact with the endless track 70 in order to induce the predetermined tension therein.

In use, starting from the neutral position (FIG. 18B), the retracted position is assumed when the shaft 312 is rotated about the longitudinal axis 320 in a first direction. This makes the connection end 316 of the shaft move laterally in a direction away from the wheel axle 62b, such that the threaded portion 317 is moved to a side of the first connection point 348 away from the wheel axle 62b. The shaft 312 moves relative to the frame 50 until the first delimiting member 321 abuts the first connection point 348 and further movement of the shaft 312 laterally in a direction away from the wheel axle 62b is not possible (FIG. 18A). This is the retracted position.

In the retracted position, the wheel axle 62b is moved closer to the first connection point. Tension in the endless track 70 is thus decreased. The resilient member 340 pushes apart the first and second member 322, 324 so that they move away from each other along the non-threaded portion of the shaft 312. The first member open end 330 is spaced from the second member open end 336.

To increase the tension in the endless track 70, whether from the neutral position or the retracted position, the shaft 312 is rotated about the longitudinal axis 320 in a second direction which is opposite to the first direction, the rotation of the shaft 312 translating the connection end 316 of the shaft towards the first connection point 348 and thus moving the wheel axle 62b away from the first connection point 348 and towards the second connection point 350.

When the trailing idler wheel assembly 60b contacts the endless track 70, there is an increased resistance to further movement of the shaft 312 towards the second connection point 350. Further rotation of the shaft 312 about the longitudinal axis 320 in the second direction therefore causes the first member 322 to move towards the second member 324 until the first and second member open ends 330, 336 abut. As the first and second members 322, 324 are brought closer together, the resilient member 340 compresses and the resistance to further rotation of the shaft 312 further increases.

The deployed position is reached when the indicator indicates one or more of the visual indicators described above. The deployed position can be maintained, and the tension in the endless track 70 maintained by virtue of the static tension applied by the threaded engagement of the shaft 312 with the frame 50.

It is understood that the indicator can be configured to indicate different positions (e.g. retracted, neutral, deployed and/or any intermediate position therebetween) as required. In addition, the indicator can be adapted to provide one or more of visual and/or “hard stop” indicators for a given model of track system (i.e. specific indicator for a specific track system) or more than one track system (i.e. a generic indicator for multiple track systems).

In order to remove the endless track 70 from the track system 20a, the steps outlined above may be reversed in order to modulate the tensioning assembly 310 from the deployed position to the retracted position.

### Embodiment 4

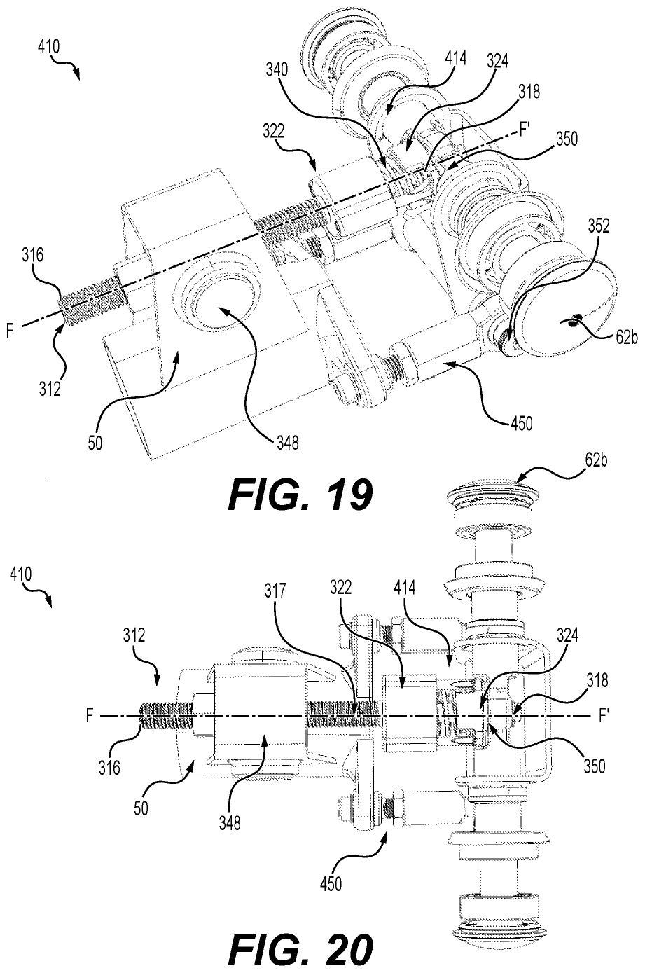

A tensioning assembly 410 according to another embodiment of the present technology will now be described with reference to FIGS. 19 to 23.

The tensioning assembly 410 differs from the tensioning assembly 310 of FIGS. 13 to 18 in that a tracking device 450 is provided. All other components of the tensioning assembly 410 are the same as those in the tensioning assembly 310 and so the same reference numerals will be used to indicate the same components such as the shaft 312, the resilient assembly 314, the first, second and third connection points 348, 350, 352 etc.

The tracking device 450 provides an adjustable connection between the frame 50 and the third connection point 352. In this respect, the tracking device comprises an arm 452 extending from the third connection point 352 to the frame 50, wherein the arm 452 has an adjustable length. It will be appreciated, that the arm 452 may comprise a pair of arms 452 extending between the frame 50 and the pair of third connection points 352, respectively.

A further difference between the tensioning assembly 410 from the tensioning assembly 310 is that the first, second and fourth connection points 348, 350, 354 comprise spherical joints. In this way, the shaft 312 is joined to the frame 50 and the wheel axle 62b by a respective spherical joint.

By means of the tracking device 450, an alignment of the endless track 70 can be facilitated when the arm 452 comprises a pair of arms 452. Each arm 452 of the pair of arms has a length that can be individually adjusted thereby adjusting an angle of the wheel axle 62b and the frame 50 by turning the respective arm clockwise or anticlockwise. For example, the arms 453 can be adjusted by varying the YAW angle (toe-in/toe-out) of the track system relative to a longitudinal plane. It is understood that the tracking device 450 may be implemented in different embodiments of the tensioning assemblies shown herein or additional configurations of tensioning assemblies.

### Embodiment 5

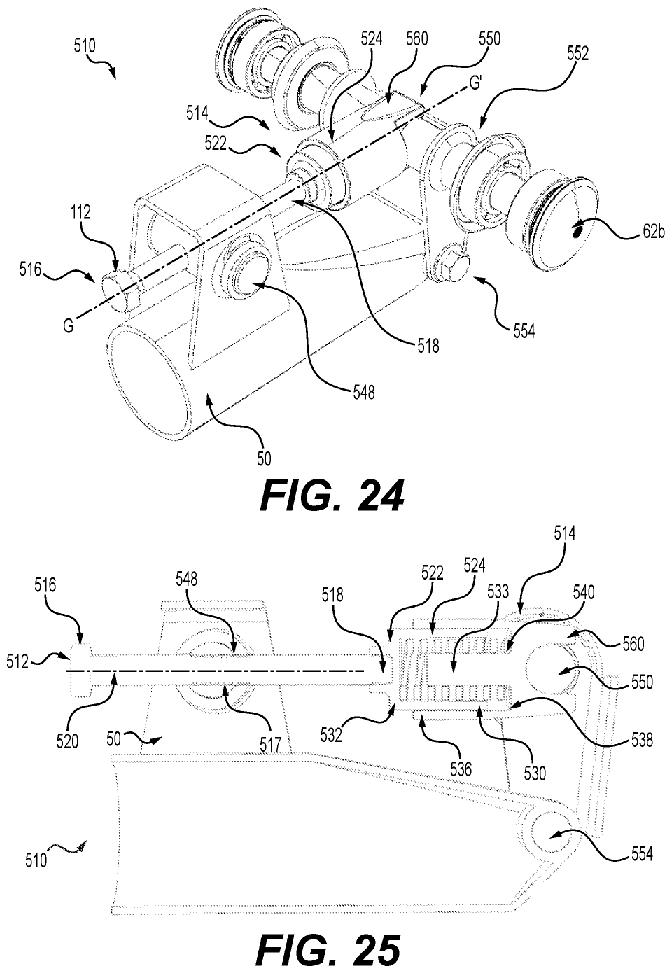

A tensioning assembly 510 according to another embodiment of the present technology will now be described with reference to FIGS. 24 to 26.

As best seen in FIG. 25, the tensioning assembly 510 comprises a shaft 512 and a resilient assembly 514. The shaft 512 is connected to the frame 50 of the track system 20a, such as the trailing frame member 54 or the lower frame member 56. The shaft has a longitudinal axis 520. The resilient assembly 514 is connected to the wheel axle 62b and operatively connected to the shaft 512 such that when the shaft 512 is rotated, the wheel axle 62b is caused to move relative to the frame 50 to modulate the tension in the endless track 70. A movement of the wheel axle 62b away from the endless track 70 and towards the frame 50 causes a decrease in the tension in the endless track 70, and a movement of the wheel axle 62b towards the endless track 70 and away from the frame 50 causes an increase in the tension in the endless track 70.

The shaft 512 is threadedly connected to the frame 50 such that rotation of the shaft 512 about the longitudinal axis 520 causes the shaft 512 to move laterally with respect to the frame 70. This lateral movement of the shaft 512 causes the movement of the resilient assembly 514 and hence the wheel axle 62b.

The shaft 512 has a connection end 516 and a free end 518 and is connected to the frame 50 at the connection end 516. The shaft 512 is elongate and extends towards the wheel axle 62b from the connection end 516. The connection end 516 is shaped so that it can be manipulated by an appropriate tool to rotate the shaft 512 about its longitudinal axis 520. The connection end 516 is configured such that a tool can be readily attached thereto. The configuration of the connection end 516 nor the type of tool that can be used is limited. In certain embodiments, the connection end 516 is configured such that it can inter-engage with a socket and ratchet tool.

The shaft 512 is disposed relative to the frame 50 such that the connection end 516 can be readily accessed by a user to modulate the tension in the endless track 70 without having to dismantle any part of the vehicle 10.

The shaft 512 is threadedly connected with the frame 50 at a first connection point 548 and is connected to the wheel axle 62b at a second connection point 550. The first connection point 548 comprises a pivotal connection between the frame 50 and the shaft 512, and the second connection point 550 comprises a pivotal connection between the wheel axle 62b and the shaft 512. As best seen in FIGS. 24 to 26, a third connection point 552 is provided between the wheel axle 62b and a fourth connection point 554. The fourth connection point 554 connects the wheel axle 62b to the frame 50. The third and fourth connection points 554 are pivotal connections. The third and fourth connection points 552, 554 may comprise a pair of third and fourth connection points 552, 554 which are disposed one on either side of the shaft 512. For ease of understanding, the description herein will refer to single connection points.

The embodiment of FIGS. 24 to 26 differs from that of FIGS. 13 to 18 in that the free end 518 of the shaft 512 is connected to the first member 522. As best seen in FIG. 25, the shaft 512 comprises a threaded portion 517 which threadedly engages with the frame 50. The shaft 512 may also include a non-threaded portion closer to the free end 518.

The shaft 512 and the wheel axle 62b are disposed on substantially the same plane. The longitudinal axis 520 of the shaft 512 and the wheel axle 62b are substantially transverse to one another on the plane.

As best seen in FIGS. 25, the resilient assembly 514 comprises a first member 522, a second member 524 and a resilient member 540. The first member 522 is substantially cylindrical and comprises a first member open end 530 and a first member base end 532. The second member 524 comprises a second member open end 536 and a second member base end 538.

The first member 522 is substantially cylindrical and comprises a first member open end 530 and a first member base end 532. The second member 554 is also substantially cylindrical and comprises a second member open end 536 and a second member base end 538. The second member 524 is configured to house at least a portion of the first member 522 such that the first member 522 nests in the second member 524. The first member open end 530 is disposed in the second member 524. The first member base end 532 is oppositely facing the second member base end 538. The second member housing base end 538 is continuous. A protrusion 533 extends from the second member base end 538 and through a central part of the resilient member 540. Arms 560 extend from the second member 524, in a direction away from the protrusion 533, and clamp to the wheel axle 62b. The arms 560 stop short of joining each other. In other words, the arms 560 do not extend completely around the wheel axle 62b.

The resilient member 540 is disposed in the first member 522 and resiliently biases the second member away 524 from the first member 522. The resilient member 540 is a spring having one end in contact with the first member base end 532 and another end in contact with an internal surface of the second member base end 538. The resilient member 540 is made of a material having stable mechanical properties (e.g. Young's Modulus, tension/compression properties) over a range of temperature of operation of the vehicle. The range of temperature over which the material is stable comprises about −40 degC to about 60 degC. In certain embodiments, the resilient member 540 is a spring made of steel. In certain other embodiments, the resilient member 540 is made from die steel, or a polymeric material such as polyurethane. In certain embodiments, the resilient member 540 is preloaded. The preloading may comprise a compression of the resilient member 540 up to more than about 80% of its total possible compression. In other embodiments, the preloading may comprise a compression of about 70%, 75%, 85% or 90% of its potential total compression. For example, in one embodiment, the resilient member 540 is a spring and has a total possible compression of 0.300 inches, and the preloading comprises a compression of 0.25 inches. By preloading the resilient member 540 in this manner, loss of tension or tooth skipping is reduced, minimized or avoided. The resilient member 540 need not be a spring and may have any other suitable configuration with stable and predictable elastic properties. In certain embodiments, the resilient member 540 comprises a belleville washer. The resilient member 540 has a length which is modulated responsive to the relative movement of the first and second members 522, 524 when the shaft 512 is rotated about its longitudinal axis 520, wherein the length is selected such that the resilient member 540 is compressed when the first member 522 and the second member 524 are in the predetermined position.

An indicator provides an indication when the wheel axle 62b is in a predetermined position corresponding to a predetermined tension in the endless track 70. The indication is based on one or both of (i) a predetermined position of the shaft 512 relative to the frame 50, and (ii) a predetermined relative position of the first and second members 522, 524. A user can be informed by the indicator of the predetermined tension in the endless track 70 being reached without having to disassemble parts of the track system 20a or the vehicle 10.

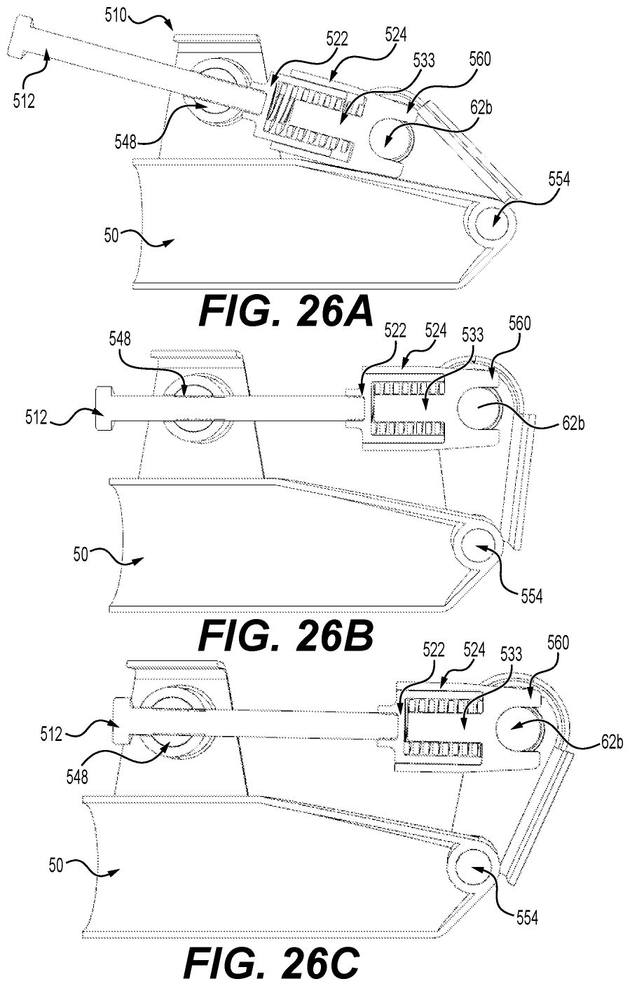

As illustrated in FIG. 26B, the indicator comprises a “hard stop” of a relative movement of the first and second members 522, 524 to each other when the shaft 512 is being rotated about its longitudinal axis 520. In this respect, the indicator is a tactile indicator which the user will feel as they rotate the shaft 512 using a tool at the connection end 516. The first and second members 522, 524 are sized and shaped such that the first member open end 530 can abut the internal surface of the second member base end 538 when the shaft 512 is rotated about its longitudinal axis 520. When the first member open end 530 abuts the internal surface of the second member base end 538, a relative position of the first and second and second members 522, 524 to each other causes the wheel axle 62b to assume the predetermined position relative to the frame 50 and the endless track 70 so as to impart the predetermined tension on the endless track 70. As the first member open end 530 approaches the internal surface of the second member base end 538, the resilient member 540 is compressed thereby providing an increased resistance to turning of the shaft 512 closer to the predetermined position, which provides a further tactile indication.

The indicator also comprises a visual indication that the predetermined tension in the endless track 70 has been reached. In this respect, the first and second members 522, 524 are sized and shaped such that the first member base end 532 is flush (aligned) with the second member open end 536 when the first member open end 530 abuts the internal surface of the second member base end 538. Alternatively, the visual indication may comprise any other alignment between the first and second members 522, 524 which can be determined visually. For example, the visual indication may comprise a predetermined spacing between the first member base end 532 and the second member housing open end 536. One or more markings may be provided on any of the first member 522, the second member 524, the shaft 512 or the frame 50 as the visual indication.

It will be appreciated that in certain other embodiments (not shown), the indicator comprises the visual indication without the “hard stop”. In other words, the first and second members 522, 524 are sized and shaped such that the first member base end 532 is flush with the second member housing open end 536 when the predetermined wheel axle 62b position, and hence the predetermined tension in the endless track 70, is attained without the first member open end 530 abutting the internal surface of the second member housing base end 538.

In certain embodiments, the indication is a distance between two parts of the resilient member 540, for example a distance between two coils of a spring when the resilient assembly 540 is a spring. In this respect, a tool may be provided for verifying a distance between the two parts, such as a gage.

A mode of operation of the tensioning assembly 510 will now be described with specific reference to FIGS. 26A, 26B and 26C. The shaft 512 and the resilient assembly 514 is configured to move between a retracted position (FIG. 26A), a neutral position (FIG. 26B) and a deployed position (FIG. 26C). The tension in the endless track 70 is higher when the tensioning assembly 514 is in the deployed position compared to the neutral and retracted positions. The deployed position of the resilient assembly 514 is utilized when the vehicle 10 is in operation (moving), and the retracted position is utilized for removing and installing the endless track 70 from the vehicle 10.

The first and second members 522, 524 have a predetermined position relative to each other, as well as having a predetermined positioned relative to the shaft 512 in the deployed positions. The resilient assembly 514 is positioned closer to the connection end 516 of the shaft 512 in the retracted position compared to the deployed position. The first and second members 522, 524 are positioned closer to the endless track 70 in the deployed position compared to the retracted position. In this respect, in the retracted position, a pressure that the trailing idler wheel assembly 60b applies to the inner surface of the endless track 70 is decreased such that a significant portion of the tension within the endless track 70 is released. In some embodiments, the trailing idler wheel assembly 60b may or may not retain its contact with the endless track 70. Whereas in the deployed position, the trailing idler wheel assembly 60b is in contact with the endless track 70 in order to induce the predetermined tension therein.

In use, starting from the neutral position (FIG. 26B), the retracted position is assumed when the shaft 512 is rotated about the longitudinal axis 520 in a first direction. This makes the connection end 516 of the shaft move laterally in a direction away from the wheel axle 62b, such that the shaft 512 is moved to a side of the first connection point 548 away from the wheel axle 62b. The shaft 512 moves relative to the frame 50 until the first member 522 abuts the first connection point 548 and further movement of the shaft 512 laterally in a direction away from the wheel axle 62b is not possible (FIG. 26A). This is the retracted position.

In the retracted position, the wheel axle 62b is moved closer to the first connection point 548. Tension in the endless track 70 is thus decreased. The resilient member 540 pushes apart the first and second member 522, 524 so that they move away from each other. The first member base end 532 is spaced from the second member open end 536.

To increase the tension in the endless track 70, whether from the neutral position or the retracted position, the shaft 512 is rotated about the longitudinal axis 520 in a second direction which is opposite to the first direction, the rotation of the shaft 512 translating the connection end 516 of the shaft 512 towards the first connection point 548 and thus moving the wheel axle 62b away from the first connection point 548 and towards the second connection point 550.

When the trailing idler wheel assembly 60b contacts the endless track 70, there is an increased resistance to further movement of the shaft 512 towards the second connection point 550. Further rotation of the shaft 512 about the longitudinal axis 520 in the second direction therefore causes the first member 522 to move towards the second member 524 until the first member open end 530 abuts the second member base end 538. As the first and second members 522, 524 are brought closer together, the resilient member 540 compresses and the resistance to further rotation of the shaft 512 further increases.

The deployed position is reached when the indicator indicates one or more of the hard stop or the visual indicators described above. The deployed position can be maintained, and therefore the tension in the endless track 70 maintained by virtue of the static tension applied by the threaded engagement of the shaft 512 with the frame 50.

It is understood that the indicator can be configured to indicate different positions (e.g. retracted, neutral, deployed and/or any intermediate position therebetween) as required. In addition, the indicator can be adapted to provide one or more of visual and/or “hard stop” indicators for a given model of track system (i.e. specific indicator for a specific track system) or more than one track system (i.e. a generic indicator for multiple track systems).

In order to remove the endless track 70 from the track system 20a, the steps outlined above may be reversed in order to modulate the tensioning assembly 510 from the deployed position to the retracted position.

### Embodiment 6

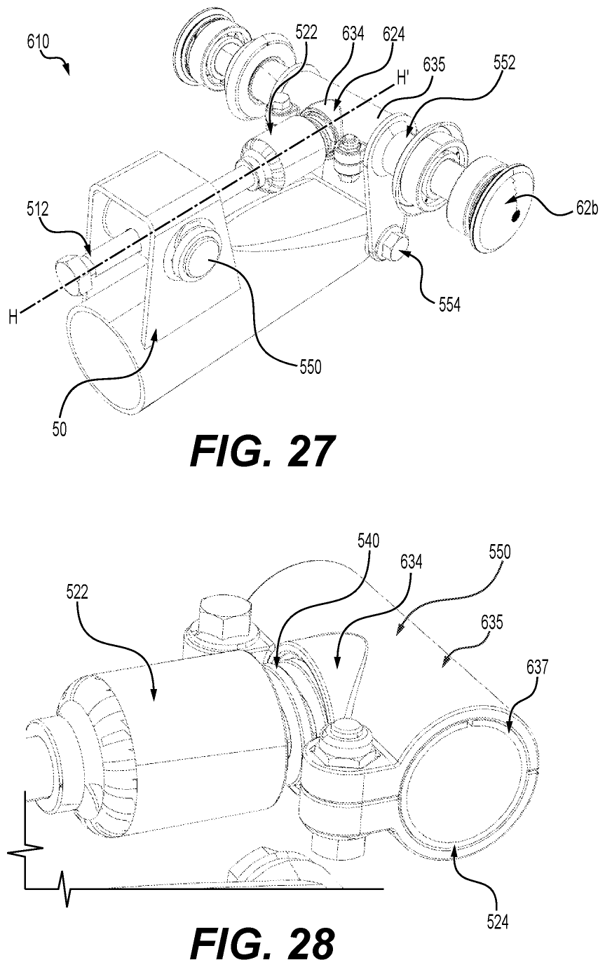

A tensioning assembly 610 according to another embodiment of the present technology will now be described with reference to FIGS. 27 to 30.

The tensioning assembly 610 differs from the tensioning assembly 510 of FIGS. 24 to 26 with a respect to a second member 624 and the manner in which the second member 624 is connected to the wheel axle 62b. All other components of the tensioning assembly 610 are the same as those in the tensioning assembly 510 and so the same reference numerals will be used to indicate the same components such as the shaft 512, the resilient assembly 514, the first member 522 524, the resilient member 540, the first, second, third and fourth connection points 548, 550, 552, 554 etc.

As best seen in FIGS. 27, 28 and 29, the second member 624 of the tensioning assembly 610 comprises a second member housing portion 634 which is generally cylindrical in shape. The second member housing portion 634 comprises a second member housing open end 636 and a second member housing base end 638. A protrusion 633 extends from the second member housing base end 638. Unlike the second member 524 in which the protrusion 533 stops short of the second member open end 536, in the tensioning assembly 610, the protrusion 633 extends beyond the second member housing open end 636. The second member 624 further comprises a second member attachment portion 635 extending from the second member housing portion 634. Unlike the arms 560 of the second member 524, the second member attachment portion 635 comprises a tube which extends around the wheel axle 62b. An axis of the tube is transverse to an axis of the protrusion 633 providing the second member 624 with a T-shaped configuration. The second member 624 comprises two lateral halves which are bolted together. However, the second member 624 may also be one piece or have multiple pieces that are attached in any other way. The second member attachment portion 635 has an inner sleeve 637. The visual indicator comprises a predetermined distance between the first member 522 and the second member 624, which may be zero, when the open end 530 of the first member 524 abuts the second member housing open end 636. The indicator may also comprise a hard stop when an end of the protrusion 633 abuts the base end 532 of the first member 522.

### Embodiment 7

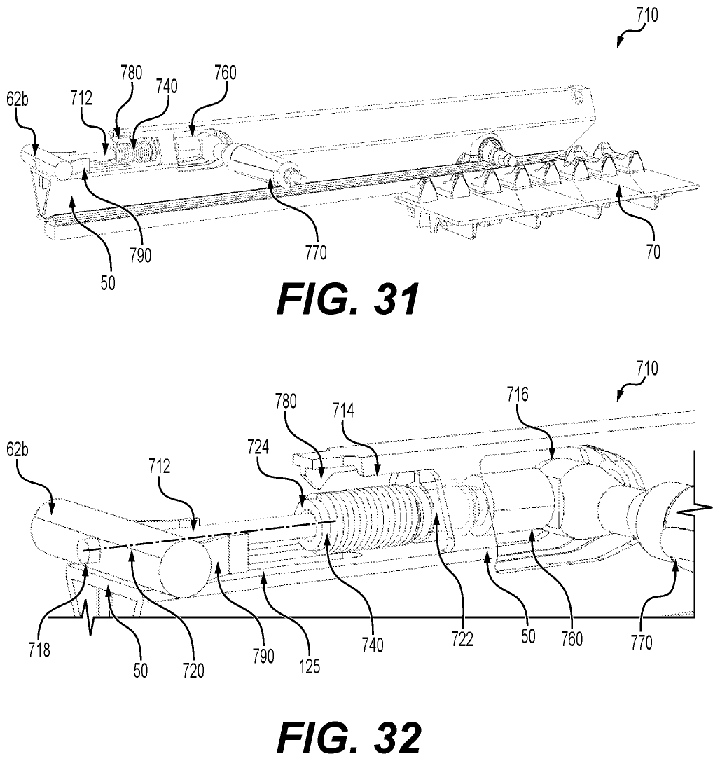

Turning now to FIGS. 31 to 35, a seventh embodiment of the present technology will be described.

A tensioning assembly 710 comprises a shaft 712 and a resilient assembly 714. The shaft 712 is slidably connected to the frame 50 of the track system 20a, such as the trailing frame member 54 or the lower frame member 56. The resilient assembly 714 is connected to the wheel axle 62b and operatively connected to the shaft 712 such that when the shaft 712 is rotated, the wheel axle 62b is caused to move relative to the frame 50 to modulate the tension in the endless track 70. A movement of the wheel axle 62b away from the endless track 70 and towards the frame 50 causes a decrease in the tension in the endless track 70, and a movement of the wheel axle 62b towards the endless track 70 and away from the frame 50 causes an increase in the tension in the endless track 70.

The shaft 712 has a connection end 716 and a free end 718, and is connected to the wheel axle 62b at the free end 716. As best seen in FIG. 32, the shaft 712 is elongate and has a longitudinal axis 720. The connection end 718 is shaped so that it can be manipulated by a tool 770 to rotate the shaft 712 about its longitudinal axis 720. The shaft 712 is disposed relative to the frame 50 such that the connection end 716 can be readily accessed by a user to modulate the tension in the endless track 70 without having to dismantle any part of the vehicle 10. In this respect, a frame opening 760 is defined in the frame 50 at the connection end 716 of the shaft 712 for ease of access to the connection end 716 with the tool 770. The connection end 716 is configured such that the tool 770 can be readily attached thereto. The configuration of the connection end 716 nor the type of tool that can be used is limited. In certain embodiments, the connection end 716 is configured such that it can inter-engage with a socket and ratchet tool.

The shaft 712 and the wheel axle 62b are disposed on substantially the same plane. The longitudinal axis 720 of the shaft 712 and the wheel axle 62b are substantially transverse to one another.

The resilient assembly 714 is configured to convert rotational movement of the shaft 712 about the longitudinal axis 720 to a linear movement of the wheel axle 62b away or towards the endless track 70 and the frame 50.

As best seen in FIGS. 32 and 34, the resilient assembly 714 comprises a first member 722 connected to the frame 50. The first member 722 has a longitudinal axis 726. The shaft 712 extends through the first member 722. The first member 722 is threadedly connected to the shaft 712. The threaded connection of the first member 722 to the frame 50 comprises corresponding threads defined on corresponding portions of the first member 722 and the frame 50. The first member 722 may comprise a threaded bushing.

Rotation about the longitudinal axis 720 of the shaft 712 causes the shaft 712 to be translated in a direction parallel to the longitudinal axis 720 of the shaft 712 and to the longitudinal axis 726 of the first member 722.

The resilient assembly 714 comprises a second member 724 which is connected to the shaft 712. The second member 724 is a shoulder extending from the shaft 712 between the connection end 716 and the free end 718.

As best seen in FIG. 32, a portion of the frame 50 has a frame face 125 which is parallel to the longitudinal axis 720 of the shaft 712 and the longitudinal axis 726 of the first member 722. The shaft 712 and the first member 722 are spaced from the frame face 125.

A resilient member 740 is disposed between the first member 722 and the second member 724 and resiliently biases the first and second members 722, 724 away from each other. The resilient member 740 is a spring having one end in contact with the first member 722 and another end in contact with the second member 724. The resilient member 740 resiliently biases the shaft 712 and hence the wheel axle 62b towards the endless track 70. The resilient member 740 is made of a material having stable mechanical properties (e.g., Young's Modulus, tension/compression properties) over a range of temperature of operation of the vehicle. The range of temperature over which the material is stable comprises about −40 degC to about 60 degC. In certain embodiments, the resilient member 740 is a spring made of steel. In certain other embodiments, the resilient member 740 is made from die steel, or a polymeric material such as polyurethane. In certain embodiments, the resilient member 740 is preloaded. The preloading may comprise a compression of the resilient member 740 up to more than about 80% of its total possible compression. In other embodiments, the preloading may comprise a compression of about 70%, 75%, 85% or 90% of its potential total compression. For example, in one embodiment, the resilient member 740 is a spring and has a total possible compression of 0.300 inches, and the preloading comprises a compression of 0.25 inches. By preloading the resilient member 740 in this manner, loss of tension or tooth skipping is reduced, minimized or avoided. The resilient member 740 need not be a spring and may have any other suitable configuration with stable and predictable elastic properties. In certain embodiments, the resilient member 740 comprises a belleville washer.

An indicator provides an indication when the wheel axle 62b is in a predetermined position corresponding to a predetermined tension in the endless track 70. A user can be informed by the indicator of the predetermined tension in the endless track 70 being reached without having to disassemble parts of the track system 20a or the vehicle 10.

The indicator comprises a visual indication that the predetermined tension in the endless track 70 has been reached. In this respect, the indicator comprises a pointer 780 connected to an upper portion of the frame 50. The upper portion of the frame 50 faces the frame face 125. The pointer 770 is thus spaced from the resilient member 740 and points downwardly towards the resilient member 740 and the second member 724. The indicator indicates that the wheel axle 62b is in the predetermined position when the pointer 770 is aligned with an alignment point on the shaft 712 (such as a mark) or on the resilient member (such as the second member 724 or a mark on the resilient member 740).

In addition to, or instead of, the abovementioned indicators, a further indication can be provided based on a predetermined assembled position of the first member 722 and/or the second member 724 relative to the frame 50. In this respect, the indicator may comprise a mark on the frame face, an alignment of the first and/or second member 722, 724 with the mark indicating the predetermined assembly position.

In certain embodiments, the indication is a distance between two parts of the resilient member 740, for example a distance between two coils of a spring when the resilient assembly 740 is a spring. In this respect, a tool may be provided for verifying a distance between the two parts, such as a gage.

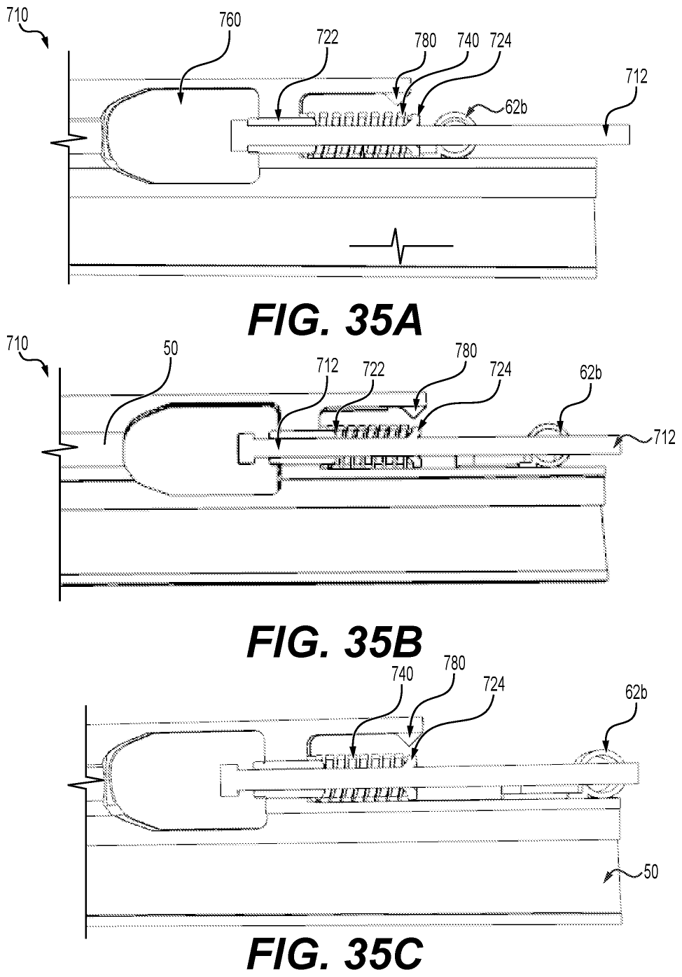

In use, starting from the neutral position (FIG. 35B), the retracted position is assumed when the shaft 712 is rotated about the longitudinal axis 720 in a first direction. This makes the shaft 712 move laterally in a direction away from the wheel axle 62b. The shaft 712 moves relative to the frame 50 so that the second member 724 approaches the first member 724 and the resilient member 740 is compressed. This is the retracted position in which tension in the endless track 70 is decreased.

To increase the tension in the endless track 70, whether from the neutral position or the retracted position, the shaft 712 is rotated about the longitudinal axis 720 in a second direction which is opposite to the first direction, the rotation of the shaft 712 translating the shaft 712 towards the wheel axle 62b away from the first member 722.

When the trailing idler wheel assembly 60b contacts the endless track 70 or increases a pressure on the endless track 70, there is an increased resistance to further movement of the shaft 712 towards the wheel axle 62b.

The deployed position is reached when the indicator indicates the visual indicator described above. The deployed position can be maintained, and therefore the tension in the endless track 70 maintained by virtue of a frictional force between arms 790 extending from the wheel axle 62b against the frame face 125. The arms 790 may have a different configuration in other embodiments, such as the form of the second member plate portion 144 or the sliding member 244. It is understood that the indicator can be configured to indicate different positions (e.g. retracted, neutral, deployed and/or any intermediate position therebetween) as required. In addition, the indicator can be adapted to provide one or more of visual and/or “hard stop” indicators for a given model of track system (i.e. specific indicator for a specific track system) or more than one track system (i.e. a generic indicator for multiple track systems).

In order to remove the endless track 70 from the track system 20a, the steps outlined above may be reversed in order to modulate the tensioning assembly 710 from the deployed position to the retracted position.

### Embodiment 8

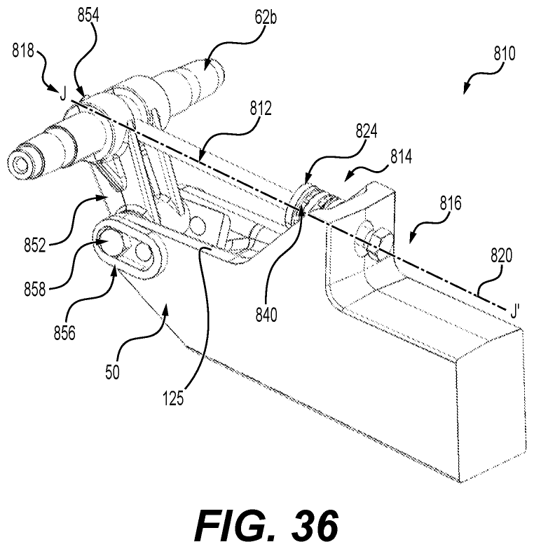

Turning now to FIGS. 36 to 39, an eighth embodiment of the present technology will be described.

A tensioning assembly 810 comprises a shaft 812 and a resilient assembly 814. The shaft 812 is slidably connected to the frame 50 of the track system 20a, such as the trailing frame member 54 or the lower frame member 56. The resilient assembly 814 is connected to the wheel axle 62b and operatively connected to the shaft 812 such that when the shaft 812 is rotated, the wheel axle 62b is caused to move relative to the frame 50 to modulate the tension in the endless track 70. A movement of the wheel axle 62b away from the endless track 70 and towards the frame 50 causes a decrease in the tension in the endless track 70, and a movement of the wheel axle 62b towards the endless track 70 and away from the frame 50 causes an increase in the tension in the endless track 70.

The shaft 812 has a connection end 816 and a free end 818, and is connected to the wheel axle 62b at the free end 818. The shaft 812 is threaded so that the free end 818 is threadedly connected to the wheel axle 62b. This allows the shaft 812 to move through the wheel axle 62b when rotated in one direction or the other direction. As best seen in FIG. 36, the shaft 812 is elongate and has a longitudinal axis 820. The connection end 816 is shaped so that it can be manipulated by a tool (not shown) to rotate the shaft 812 about its longitudinal axis 820. The shaft 812 is disposed relative to the frame 50 such that the connection end 816 can be readily accessed by a user to modulate the tension in the endless track 70 without having to dismantle any part of the vehicle 10. A frame opening may be defined in the frame 50 at the connection end 816 of the shaft 812 for ease of access to the connection end 816 with the tool. The connection end 816 is configured such that the tool can be readily attached thereto. The configuration of the connection end 816 nor the type of tool that can be used is limited. In certain embodiments, the connection end 816 is configured such that it can inter-engage with a socket and ratchet tool.

The shaft 812 and the wheel axle 62b are disposed on substantially the same plane. The longitudinal axis 820 of the shaft 812 and the wheel axle 62b are substantially transverse to one another.

The resilient assembly 814 is configured to convert rotational movement of the shaft 812 about the longitudinal axis 820 to a linear movement of the wheel axle 62b away or towards the endless track 70 and the frame 50.

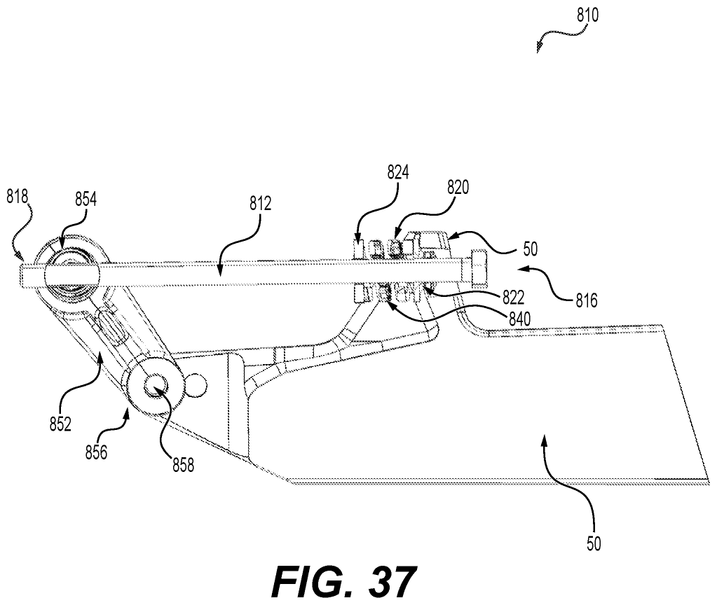

As best seen in FIG. 37, the resilient assembly 814 comprises a first member 822 connected to the frame 50. The shaft 812 extends through the first member 822. In this embodiment, the first member 822 is a bushing. The resilient assembly 814 comprises a second member 824 which is connected to the shaft 812. The second member 824 is a shoulder extending from the shaft 812 between the connection end 816 and the free end 818. The shaft 812 is slidably connected to the first member 822. The resilient member 840 is positioned between the second member 824 and the first member 822. The first member 822 is pivotably connected to the frame 50 such that the first member 822 can pivot as if it were connected to a spherical joint which gives the necessary degree of freedom to move between the deployed and retracted positions. It is understood that other configurations and embodiments of the first member 822 are contemplated. For instance, the first member 822 can be configured to provide a spherical joint or a universal joint connecting to the frame 50.

As best seen in FIG. 36, a portion of the frame 50 has the frame face 125 which faces the longitudinal axis 820 of the shaft 812. The shaft 812, the first member 822 and the second member 824 are spaced from the frame face 125.

A resilient member 840 is disposed between the first member 822 and the second member 824 and resiliently biases the first and second members 822, 824 away from each other. In this embodiment, the resilient member 840 is a spring having one end in contact with the first member 822 and another end in contact with the second member 824. The resilient member 840 resiliently biases the shaft 812 and hence the wheel axle 62b towards the endless track 70. The resilient member 840 is made of a material having stable mechanical properties (e.g., Young's Modulus, tension/compression properties, etc.) over a range of temperature of operation of the vehicle. The range of temperature over which the material is stable comprises about −40 degC to about 60 degC. In certain embodiments, the resilient member 840 is a spring made of steel. In certain other embodiments, the resilient member 840 is made from die steel, or a polymeric material such as polyurethane. In certain embodiments, the resilient member 840 is preloaded. The preloading may comprise a compression of the resilient member 840 up to more than about 80% of its total possible compression. In other embodiments, the preloading may comprise a compression of about 70%, 75%, 85% or 90% of its potential total compression. For example, in one embodiment, the resilient member 840 is a spring and has a total possible compression of 0.300 inches, and the preloading comprises a compression of 0.25 inches. By preloading the resilient member 840 in this manner, loss of tension or tooth skipping is reduced, minimized or avoided. The resilient member 840 need not be a spring and may have any other suitable configuration with stable and predictable elastic properties. In certain embodiments, the resilient member 840 comprises a belleville washer.

The tensioning assembly 810 differs from the tensioning assembly 710 in that the wheel axle 62b is connected to the frame 50 by a pivot member 852. The pivot member 852 has a first end 854 which is rotatably connected to the wheel axle 62b, and a second end 856 which is rotatably connected to the frame 50.

The pivot member 852 is pivotably connected to the frame 50 by a bolt 858. In certain embodiments, the frame 50 provides two different positions for the bolt 858 depending on a diameter of a first sprocket and a diameter of a second sprocket different from the first sprocket. This can permit maintaining the same tensioning assembly 810 parts and changing the pivot position to fit the tensioning assembly 810 to the second sprocket. In certain embodiments, there may be provided a different pivot member 852 having a different length to accommodate a different diameter sprocket.

An indicator provides an indication when the wheel axle 62b is in a predetermined position corresponding to a predetermined tension in the endless track 70. A user can be informed by the indicator of the predetermined tension in the endless track 70 being reached without having to disassemble parts of the track system 20a or the vehicle 10.

The indicator comprises a visual indication that the predetermined tension in the endless track 70 has been reached. In this respect, in certain embodiments, the indicator comprises an extension of the free end 818 of the shaft 812. In certain embodiments, the indicator is based on a predetermined assembled position of the first member 822 and/or the second member 824 relative to the frame 50. In this respect, the indicator may comprise a mark on the frame face, an alignment of the first and/or second member 822, 824 with the mark indicating the predetermined assembly position. In certain embodiments, the indicator is a distance between two parts of the resilient member 840, for example a distance between two coils of the spring when the resilient assembly 840 is the spring. In this respect, a tool (not shown) may be provided for verifying a distance between the two parts, such as a gage.

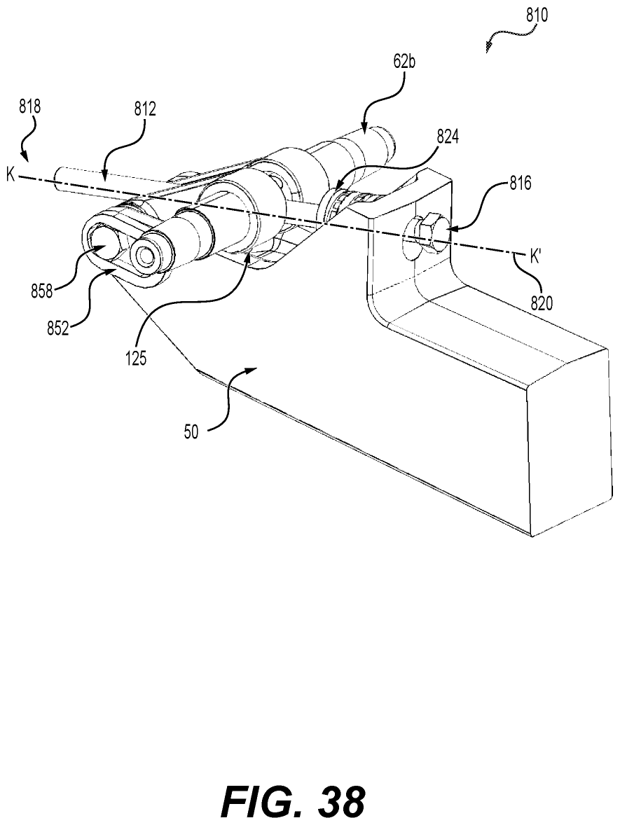

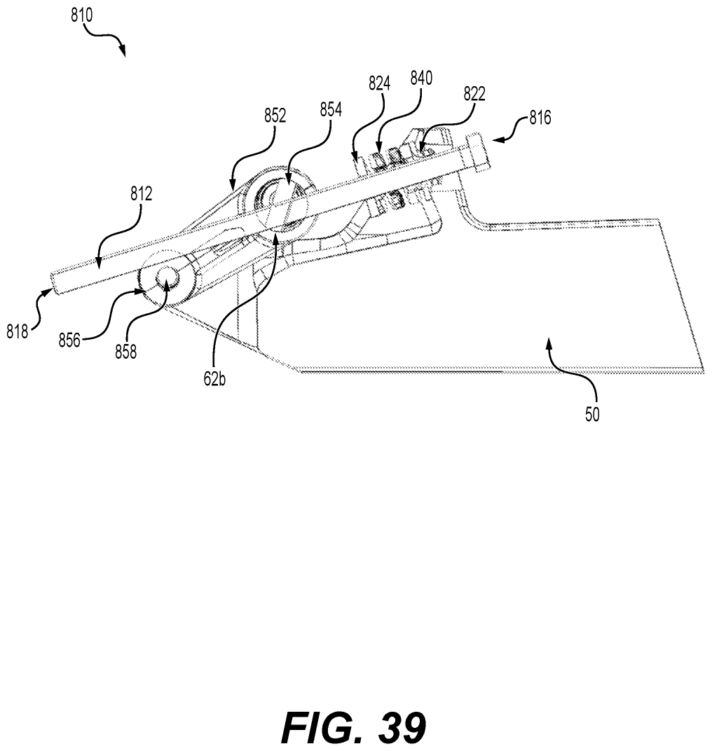

In use, rotating the shaft 812 moves the tensioning assembly 810 between the deployed position (FIGS. 36 and 37) and the retracted position (FIGS. 38 and 39). The retracted position is assumed when the shaft 812 is rotated about the longitudinal axis 820 in a first direction. This makes the shaft 812 move laterally in a direction away from the wheel axle 62b. The shaft 812 moves relative to the frame 50 so that the first and second members 822, 824 come closer and the resilient member 840 is compressed. At the same time as the shaft 812 is being caused to move, the pivot member 852 is caused to pivot. In this way, the free end 818 of the shaft 812 is caused to extend away from the wheel axle 62b. In the retracted position, tension in the endless track 70 is decreased. In the retracted position the first end 854 of the pivot member 852 is disposed between the second end 856 of the pivot member and the resilient assembly 814.

To increase the tension in the endless track 70, the shaft 812 is rotated about the longitudinal axis 820 in a second direction which is opposite to the first direction, the rotation of the shaft 812 translating the free end 818 of the shaft 812 towards the wheel axle 62b. In the deployed position, the second end 856 of the pivot member is disposed between the first end 854 of the pivot member 852 and the resilient assembly 814.

When the trailing idler wheel assembly 60b contacts the endless track 70 or increases a pressure on the endless track 70, there is an increased resistance to further movement of the shaft 712 towards the wheel axle 62b.

The deployed position is reached when the indicator indicates the visual indicator described above. It is understood that the indicator can be configured to indicate different positions (e.g. retracted, neutral, deployed and/or any intermediate position therebetween) as required. In addition, the indicator can be adapted to provide one or more of visual and/or “hard stop” indicators for a given model of track system (i.e. specific indicator for a specific track system) or more than one track system (i.e. a generic indicator for multiple track systems).

In order to remove the endless track 70 from the track system 20a, the steps outlined above may be reversed in order to modulate the tensioning assembly 810 from the deployed position to the retracted position.

### Embodiment 9

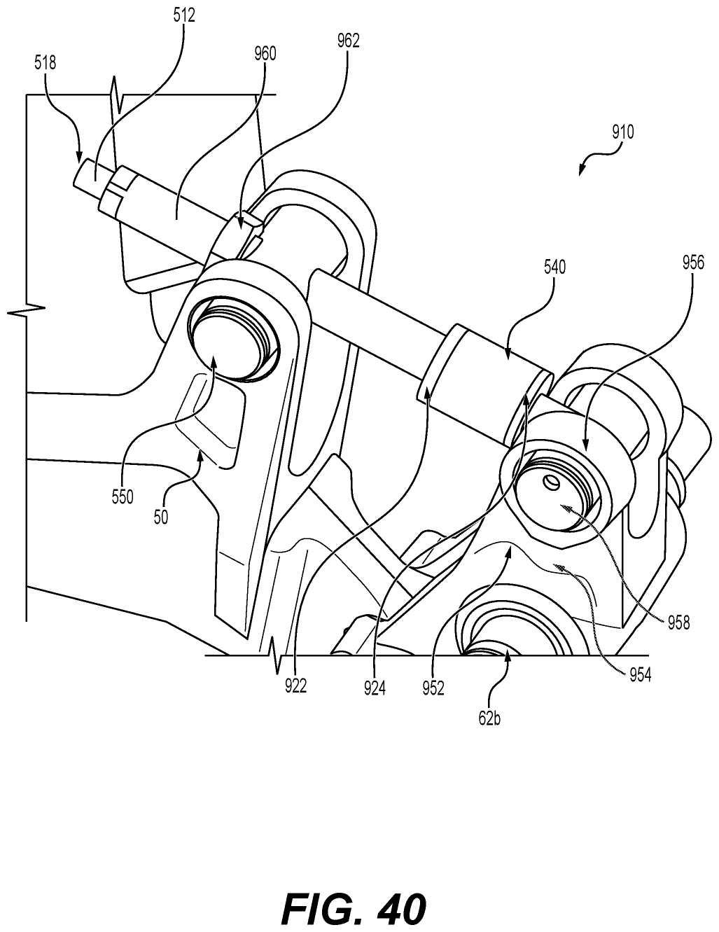

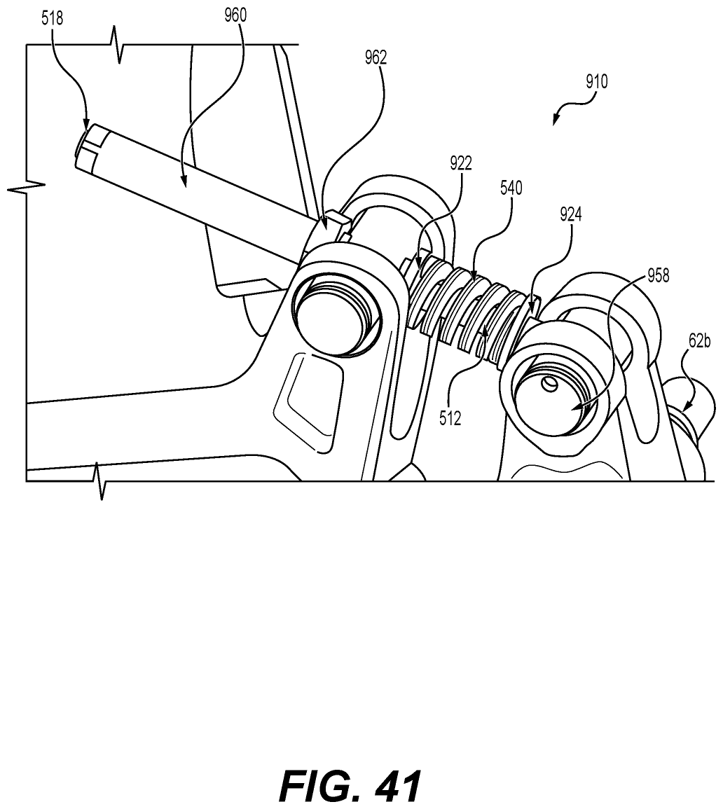

Turning now to FIGS. 40 and 41, a tensioning assembly 910 according to a ninth embodiment of the present technology will be described.

The tensioning assembly 910 differs from the tensioning assembly 610 of FIGS. 27 to 29 in that a second member 924 is connected to the wheel axle 62b via a pivot member 952 having a first end 954 and a second end 956. The pivot member 952 extends upwardly from the wheel axle 62. The first end 954 of the pivot member 952 is connected to the wheel axle 62b. The second end 956 of the pivot member is connected to a connection point 958. The connection of the second member 924 to the pivot member 952 at the connection point 958 is a pivotal connection such that an angle between the longitudinal axis 520 of the shaft 512 and a longitudinal axis of the pivot member 952 can be varied.

The shaft 512 is connected to the second member 924. In certain embodiments, the second member 924 is a shoulder extending from the shaft 512. The first member 922 is a shoulder extending from a sleeve 960. The shaft 512 extends from the second member 924, and at least a portion of the shaft 512 extends into and along the sleeve 960. The shaft 512 is slideably moveable within the sleeve 960. The resilient member 540 is positioned between the first and second members 922, 924. The sleeve 960 is pivotally connected to the frame 50 at the second connection point 550. In certain embodiments, the resilient member 540 is a spring, such as a die spring.

The first, third and fourth connection points 548, 552, 554 of the embodiment of FIGS. 27 to 29 are not present in this ninth embodiment. All other components of the tensioning assembly 910 are substantially the same as those in the tensioning assembly 610 and in parts the tensioning assembly 510 and so the same reference numerals will be used to indicate the same components such as the shaft 512, the resilient assembly 514, the resilient member 540, the second connection point 550, etc.

The tensioning assembly 910 can be modulated between deployed and retracted positions. In some embodiments, rotating the sleeve 960 causes movement of the shaft 512 relative to the frame 50 via the resilient member 540. Thus, the tensioning assembly 910 is caused to move towards the deployed position in which the tension in the endless track 70 is higher than in the retracted position. A nut 962 is in threaded connection with the sleeve 960 so that rotating the nut 962 moves the sleeve 960 and the shaft 512 toward/away from the frame 50. The nut 962 could be used as a safety measure to prevent unwanted rotation of the sleeve 960 relative to the frame 50. The nut 962 may be omitted in some embodiments.

In the deployed position (FIG. 40), the pivot member 952 is pivoted away from the frame 50 and away from the second connection point 550. The free end 518 of the shaft 512 extends out of an end of the sleeve 960.

In the retracted position (FIG. 41), the pivot member 952 is pivoted towards the frame 50 and the second connection point 550, and away from the endless track 70. The free end 518 of the shaft 512 is disposed within the end of the sleeve 960.

The indicator comprises a length of the shaft 512 extending from the sleeve 960 or a spacing between coils of the spring. For example, in order to obtain a predetermined tension in the endless track, the tensioning assembly 910 may be moved to the deployed position until a predetermined spacing between adjacent coils of the spring is measured, suing for example a feeler gage.

### Embodiment 10

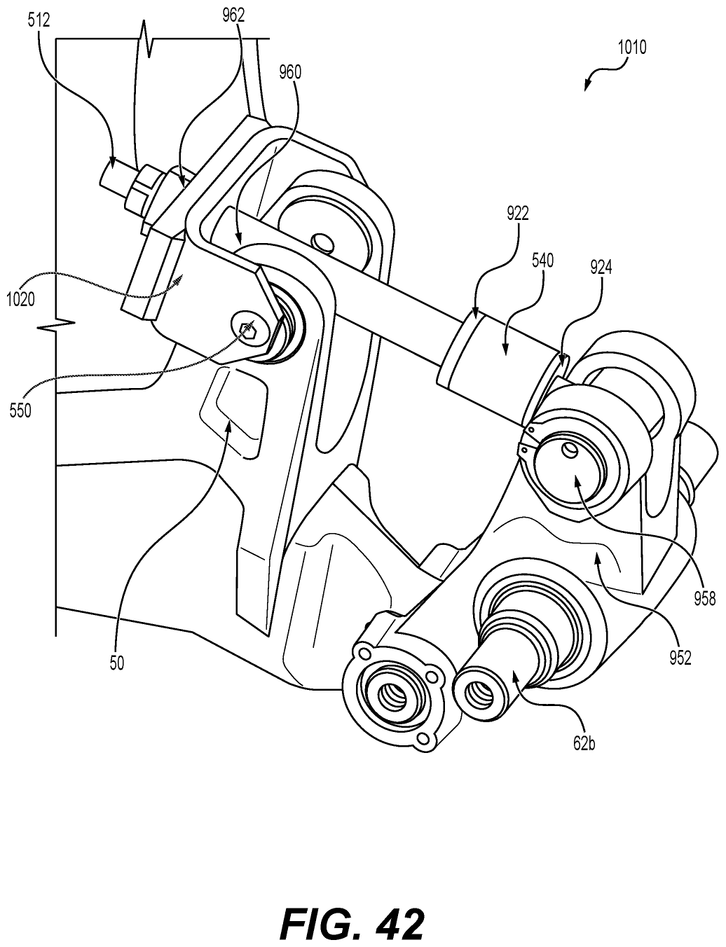

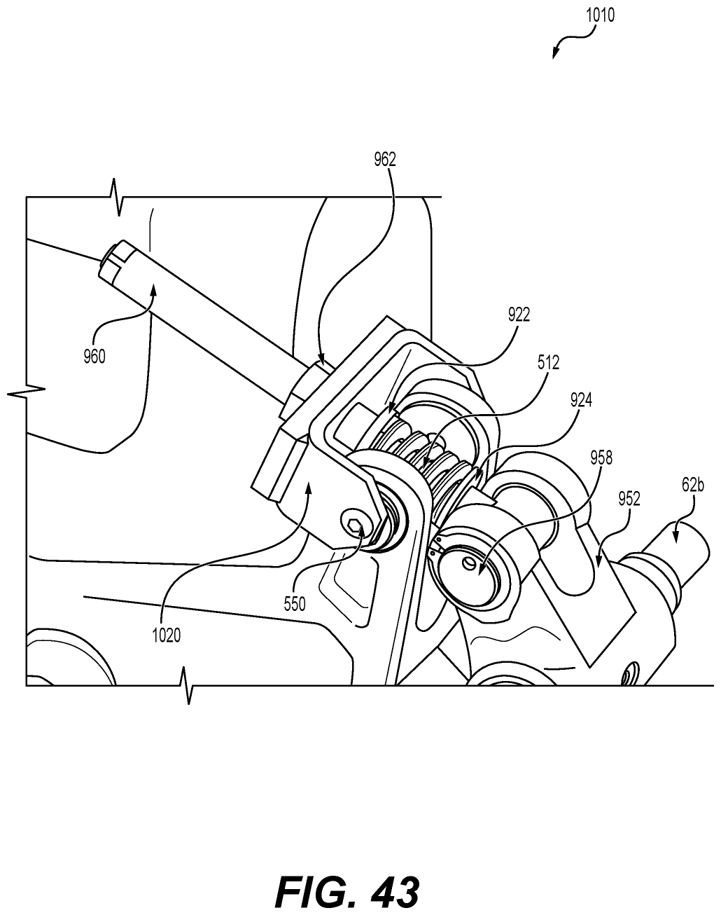

Turning now to FIGS. 42 and 43, a tensioning assembly 1010 according to a tenth embodiment of the present technology will now be described. The tensioning assembly 1010 differs from the tensioning assembly 910 in that the sleeve 960 is connected to the frame 50 at the second connection point 550 via a hinge member 1020.

This can provide, in certain embodiments, a closer position of the pivot member 952 relative to the frame 50 by offsetting an attachment point of the sleeve 960 to the pivot member 1020, which provides more space for the resilient member 540 when in retracted configuration (FIG. 43).

In some embodiments, the sleeve 960 is slidably connected to the pivot member 1020. The nut 962 is in a threaded connection with the sleeve 960 so that rotating the nut 962 moves the sleeve 960 (and the shaft 512) toward/away from the pivot member 1020. In some embodiments, the sleeve 960 is connected to the pivot member 1020 via a threaded connection so that rotating the sleeve 960 can move the sleeve 960 (and the shaft 512) toward/away from the pivot member 1020. The nut 962 could be used as a safety measure to prevent unwanted rotation of the sleeve 960 relative to the pivot member 1020 or could be omitted in some embodiments.

### Embodiment 11

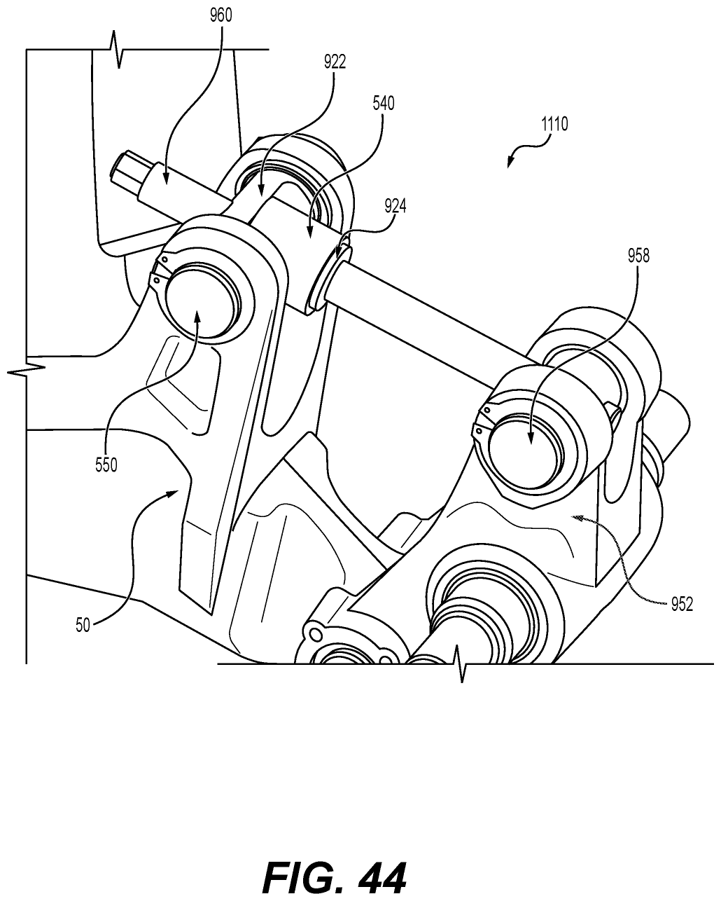

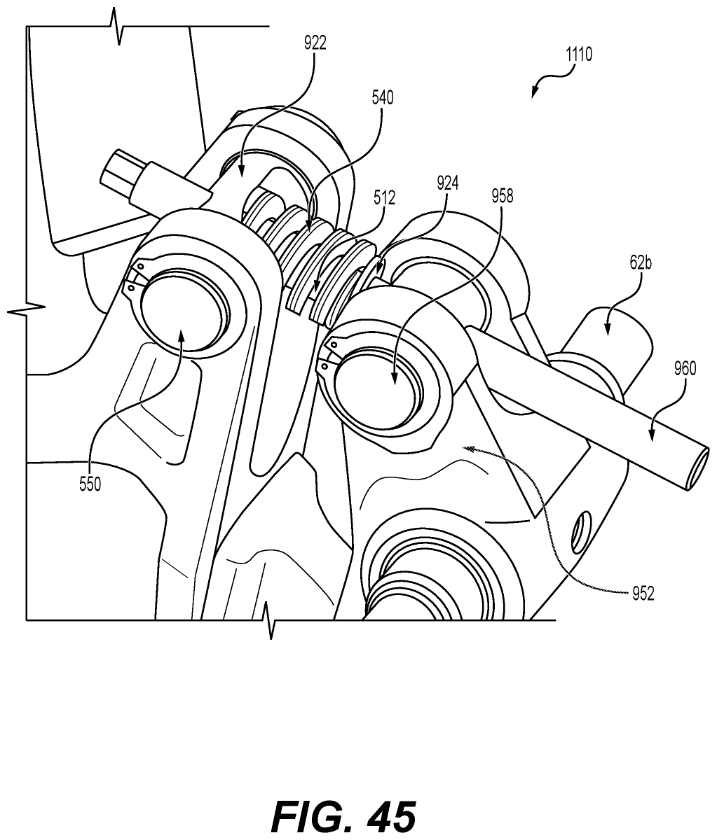

Turning now to FIGS. 44 and 45, a tensioning assembly 1110 according to an eleventh embodiment of the present technology will now be described. The tensioning assembly 1110 differs from the tensioning assembly 910 in that the first member 922 is connected to the frame 50 at the second connection point 550. The sleeve 960 extends from the second member 924. Rotating the shaft 512 causes the resilient member 540 to expand and push the sleeve 960 beyond the connection point 958 towards the retracted position (FIG. 45). It will be noted that the sleeve 960 essentially functions as a shaft, such as the shaft 512, in certain embodiments. In such embodiments, the sleeve 960 may be referred to as “the shaft 512”. The sleeve 960 is in a threaded connection with the pivot member 952 at the connection point 958, and is slidably movable with respect to the frame 50 at the second connection point 550. Rotating the sleeve 960 causes relative movement of the sleeve 960 to the pivot member 952.

Modifications and improvements to the above-described embodiments of the present invention may become apparent to those skilled in the art. The foregoing description is intended to be exemplary rather than limiting. The scope of the present invention is therefore intended to be limited solely by the appended claims.

What is claimed is:

1. A tensioning assembly for modulating a tension in a track of a vehicle track system, the vehicle track system including a wheel with a wheel axle, the track extending at least partially around the wheel, the tensioning assembly comprising:
a shaft having a longitudinal axis and being threadedly connectable at one end to the wheel axle;
a resilient assembly operatively connected to the shaft such that when the shaft is rotated about the longitudinal axis the wheel axle is caused to move away or toward the track to modulate the tension in the track, the resilient assembly comprising:
a first member connected to a frame of the vehicle track system, the shaft extending through the first member and being slidably connected thereto;
a second member connected to the shaft between the first member and the wheel axle;
a resilient member resiliently biasing the second member away from the first member;
an indicator for providing an indication when the wheel axle is in a predetermined position corresponding to a predetermined tension in the track, the indication being based on at least one of (i) a predetermined position of the first member relative to the second member, and (ii) a predetermined position of the resilient assembly relative to the frame.

2. The tensioning assembly of claim 1, wherein the second member comprises a shoulder extending from the shaft.

3. The tensioning assembly of claim 1, wherein a connection between the first member and the frame is configured to provide one of a spherical joint, universal joint and a loose joint.

4. The tensioning assembly of claim 1, wherein the first member comprises a threaded bushing.

5. The tensioning assembly of claim 1, further comprising a tool interface portion connected to the shaft, the tool interface portion being configured to be used with a ratchet and socket tool.

6. The tensioning assembly of claim 1, wherein the shaft is configured such that rotating the shaft about the longitudinal axis causes the shaft to be translated laterally towards and away from the wheel axle.

7. The tensioning assembly of claim 1, wherein the resilient member is made of a material having stable and predictable elastic properties over a range of temperature of operation of the vehicle track system.

8. The tensioning assembly of claim 7, wherein the resilient member is a spring or a belleville washer.

9. The tensioning assembly of claim 1, wherein the indicator is a visual reference or a hard stop reference.

10. The tensioning assembly of claim 9, wherein the resilient member is a spring and the visual reference is a distance between coils of the spring.

11. The tensioning assembly of claim 1, wherein the shaft and the wheel axle are positioned on substantially the same plane.

12. The tensioning assembly of claim 1, wherein the shaft is configured to move between a retracted position and a deployed position, the deployed position corresponding to the predetermined position of the wheel axle.

13. The tensioning assembly of claim 1, wherein the shaft has a connection end and a free end, wherein the shaft is connected to the wheel axle at the free end, and wherein the connection end can be accessed through an opening in the frame.

14. The tensioning assembly of claim 1, wherein the wheel axle is connected to the frame by a pivot member.

15. The tensioning assembly of claim 14, wherein the pivot member has a first end which is rotatably connected to the wheel axle, and a second end which is rotatably connected to the frame.

16. The tensioning assembly of claim 14, wherein the pivot member is connectable to the frame via at least two positions to accommodate different sizes of sprocket wheels.

17. The tensioning assembly of claim 14, wherein in the retracted position the first end of the pivot member is disposed between the second end of the pivot member and the resilient assembly.

18. The tensioning assembly of claim 14, wherein in the deployed position, the second end of the pivot member is disposed between the first end of the pivot member and the resilient assembly.

19. A track system for a vehicle, the track system comprising:
a frame;
at least one axle movably connected to the frame;
at least one wheel connected to the axle;
a track supported by the at least one axle;
the tensioning assembly of claim 1 for adjusting a tension of the track.

20. A method for adjusting a tension in a track of a vehicle track system by using a tensioning assembly according to claim 1, the method comprising: causing the shaft to be rotated about the longitudinal axis; and determining a tension in the track using the indicator.
